(19) United States
(12) Patent Application Publication
(10) Pub. No.: US 2026/0084057 A1
(43) Pub. Date: Mar. 26, 2026

(54) SYSTEMS AND METHODS FOR MODIFYING A SOUND BASED ON USER PREFERENCES

(71) Applicant: Sony Interactive Entertainment Inc., Tokyo (JP)

(72) Inventors: Victoria Dorn, San Mateo, CA (US); Andres Aceves, Harvey, IL (US)

(21) Appl. No.: 18/893,762

(22) Filed: Sep. 23, 2024

(51) Int. Cl. A63F 13/54; A63F 13/213; A63F 13/215; A63F 13/79; G06V 40/16

(52) U.S. Cl. CPC A63F 13/54; A63F 13/213; A63F 13/215; A63F 13/79; G06V 40/174

(57) ABSTRACT

Systems and methods for modifying a sound based on user preferences are described. One of the methods includes receiving first audio data of a first sound to be output from a first virtual object during a play of a game by a user. The method also includes determining, by an artificial intelligence (AI) model, that the first sound is not preferred to be heard by the user and providing an indication to a game engine that the first sound is not preferred to be heard from the user. The method includes modifying, by the game engine, the first audio data with second audio data to be output as a second sound to be heard by the user.

### FIELD

The present disclosure relates to systems and methods for modifying a sound based on user preferences are described.

### BACKGROUND

The popularity of multi-player video games has increased in recent years. The multi-player video games allows a user to connect with other users while completing certain achievements or challenges within a multi-player video game. For example, to complete certain achievements or challenges within the multi-player video game, two or more users may need to co-operate with each other. The two or more users help each other in order to overcome a certain obstacle or defeat a mutual enemy. In other examples, the two or more users to compete with each other to completing certain achievements or challenges. For example, the two or more users may be split into two or more teams, and a challenge is to obtain more points, goals, etc. than the other team.

While playing the multi-player video game, certain users may not enjoy playing the video game. This can lead to dissatisfaction with the multi-player video game, and may even lead to a sense of isolation in certain users. The user may feel that their experience of the multi-player video game is not satisfactory.

It is in this context that embodiments of the invention arise.

### SUMMARY

Embodiments of the present disclosure provide systems and methods for modifying a sound based on user preferences.

In an embodiment, an artificial intelligence (AI) model is trained to learn user preferences on game sounds. In that manner, audio from a game is adapted to reflect personal preferences of player. For example, if a certain sound bothers the player, that sound can be muted or changed when played during the game play. As such, a sound corresponding to an asset, such as a virtual object in a scene or a virtual background in the scene, may be modified based on user preferences. Similarly, some sounds can be removed, if a game allows and some sounds are protected from removal or modification as instructed by a game developer.

In one embodiment, a method for modifying a sound based on user preferences is described. The method includes receiving first audio data of a first sound to be output from a first virtual object during a play of a game by a user. The method also includes determining, by an AI model, that the first sound is not preferred to be heard by the user and providing an indication to a game engine that the first sound is not preferred to be heard from the user. The method includes modifying, by the game engine, the first audio data with second audio data to be output as a second sound preferred to be heard by the user.

In an embodiment, a server system for modifying a sound based on user preferences is described. The server system includes a processor and a memory device coupled to the processor. The processor receives first audio data of a first sound to be output from a first virtual object during a play of a game by a user. The processor determines, using an AI model, that the first sound is not preferred to be heard by the user. The processor provides an indication to a game engine that the first sound is not preferred to be heard from the user. The processor modifies, using the game engine, the first audio data with second audio data to be output as a second sound preferred to be heard by the user.

In an embodiment, a non-transitory computer-readable medium that stores instructions for modifying a sound based on user preferences is described. The instructions when executed by a computer cause the computer to receive first audio data of a first sound to be output from a first virtual object during a play of a game by a user and determine, using an AI model, that the first sound is not preferred to be heard by the user. The instructions when executed cause the computer to provide an indication to a game engine that the first sound is not preferred to be heard from the user. The instructions when executed cause the computer to modify, using the game engine, the first audio data with second audio data to be output as a second sound preferred to be heard by the user.

Some advantages of the herein described systems and methods include reducing user fatigue and stress that is caused by sounds that are not preferable to the user. An AI model determines whether the sounds are preferable to the user based on preferences of the user or of additional users or a combination thereof. In response to determining that the sounds are not preferable to the user, the systems and methods modify the sounds until the sounds are preferable to the user. When the sounds are modified to the point of their preferable to the user, the user fatigue and stress are reduced.

Further advantages include reducing resources that are used to produce sounds that are not preferable by the user. When it is determined that the sounds are not preferable to the user, resources, such as amplifiers and power sources, that amplify the sound can be utilized elsewhere or power that is provided to the resources is saved. The power sources supply power to the amplifier to amplify the sounds.

Other aspects of the present disclosure will become apparent from the following detailed description, taken in conjunction with the accompanying drawings, illustrating by way of example the principles of embodiments described in the present disclosure.

### BRIEF DESCRIPTION OF THE DRAWINGS

Various embodiments of the present disclosure are best understood by reference to the following description taken in conjunction with the accompanying drawings in which:

FIG. 1 is a diagram of an embodiment of a system to illustrate a sound that is not preferred by a user during a play of a game.

FIG. 2 is a diagram of an embodiment of a system to illustrate a sound that is not preferred by a user during a play of a game.

FIG. 3 is a diagram of an embodiment of a system to illustrate a sound that is preferred by a user during a play of a game.

FIG. 4A is a diagram of an embodiment of a system to illustrate training of an artificial intelligence (AI) model based on preferences of one or more users during play of one or more games.

FIG. 4B is a diagram of an embodiment of a system to illustrate training of the AI model based on parameter setting data.

FIG. 5 is a diagram of an embodiment of a system to illustrate a virtual scene in which a virtual monster outputs a less scary sound after the AI model is trained.

FIG. 6A is a diagram of an embodiment of a system to illustrate a method for replacing a scary sound with a less scary sound.

FIG. 6B is a diagram of a flowchart of the method of FIG. 6A.

FIG. 7 is a diagram of an embodiment of a system to illustrate a selection of a parameter and a range of the parameter for a virtual object by a user.

FIG. 8 is a diagram of an embodiment of a system to illustrate an analog slider to select a level of the parameter of a sound to be output by a virtual object in a game

FIG. 9 illustrates components of an example device, such as a client device or a server system, described herein, that can be used to perform operations of the various embodiments of the present disclosure.

### DETAILED DESCRIPTION

Systems and methods for modifying a sound based on user preferences are described. It should be noted that various embodiments of the present disclosure are practiced without some or all of these specific details. In other instances, well known process operations have not been described in detail in order not to unnecessarily obscure various embodiments of the present disclosure.

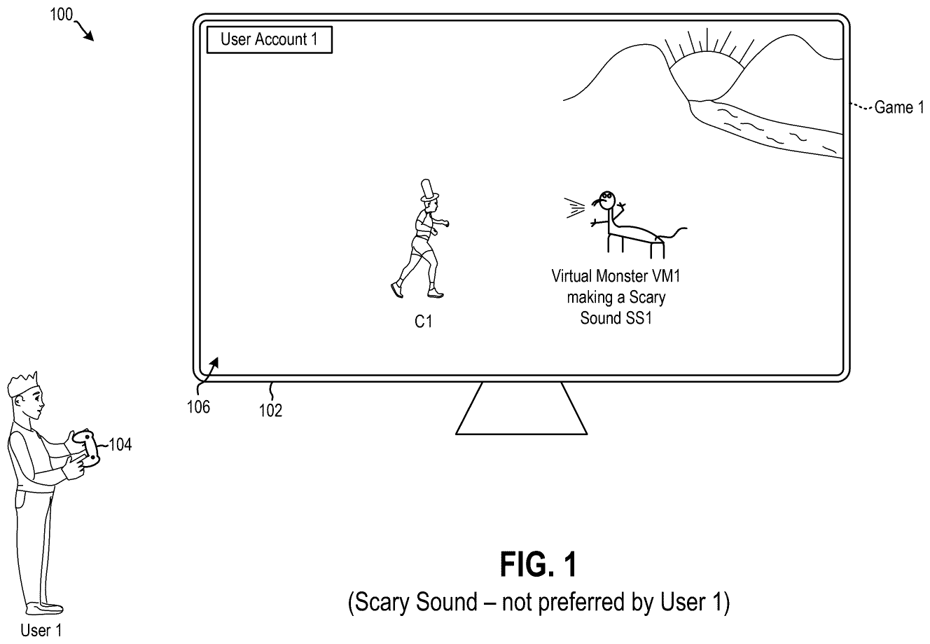

FIG. 1 is a diagram of an embodiment of a system 100 to illustrate a sound that is not preferred by a user 1 during a play of a game 1. The system 100 includes a display device 102 and a handheld controller (HHC) 104. Examples of a display device include a display of a computer, a display of a television, a display of a smart television, a display of a smart phone, and a head-mounted (HMD) display. An example of a handheld controller, as used herein, include a Sony PlayStation™ controller having input buttons, such as joysticks, for receiving operations, such as selections or movements, from a user holding the hand-held controller. Examples of a game, as described herein, include a single player video game and a multi-player video game.

The user 1 uses the HHC 104 to access a computer software program, such as the game 1, from one or more processors of a server system. For example, the user 1 uses the HHC 104 to log into a user account 1 stored on one or more memory devices of the server system to access the game 1, which is executed by the one or more processors of the server system to generate data for displaying a virtual scene 106 on the display device 102. The data for displaying the virtual scene 106 is sent from the one or more processors of the server system via a computer network to a client device operated by the user 1 for display of the virtual scene 106 on the display device 102. An example of the computer network includes a local area network or a wide area network, such as the internet, or a combination thereof. Examples of a processor include a central processing unit (CPU), a graphical processing unit (GPU), and a network interface controller (NIC).

The virtual scene 106 includes one or more virtual objects, such as a character C1 and a virtual monster VM1, and a virtual background. Examples of a virtual background in a scene include sun, mountains, and a river that provide a backdrop effect to virtual objects in the scene. The character C1 is controlled by the user 1 via the HHC 104. In the virtual scene 106, the virtual monster VM1 makes a sound, such as a scary sound or a roaring sound or a screeching sound or a high pitch sound or a high frequency sound, that is not preferred to be heard by the user 1. For example, the user 1 is bothered by or annoyed by or scared of the sound output from the virtual monster VM1.

An example of a client device operated by a user includes a combination of an HHC and a display device. To illustrate, the client device includes a microphone and a camera. Another example of a client device includes a combination of an HHC, a display device, and a game console. As an example, a client device includes one or more microphones. To illustrate, the HHC of the client device has a microphone and a camera integrated therein or the display device of the client device has a microphone and a camera integrated therein. An example of a camera of the display device is an outside-in camera of the HMD for capturing facial expressions of the user.

In an embodiment, instead of the virtual monster VM1 outputting the sound that is not preferred by the user 1, another virtual object or the virtual background of the virtual scene 106 outputs a sound that is not preferred to be heard by the user 1. For example, a train of the game 1 outputs a screeching sound when wheels of the train rub against a virtual object, such as railroad tracks, of the game 1. As another example, another virtual character of the game 1 outputs a sound of a virtual object, such as gum, being chewed. As yet another example, in the game 1, a virtual object, such as a metal, rubs against another virtual object, such as another metal, to output a sound.

In one embodiment, instead of a scary sound, any other unpreferable sound, such as an unpleasant sound, is output from a virtual object or a virtual background in a game.

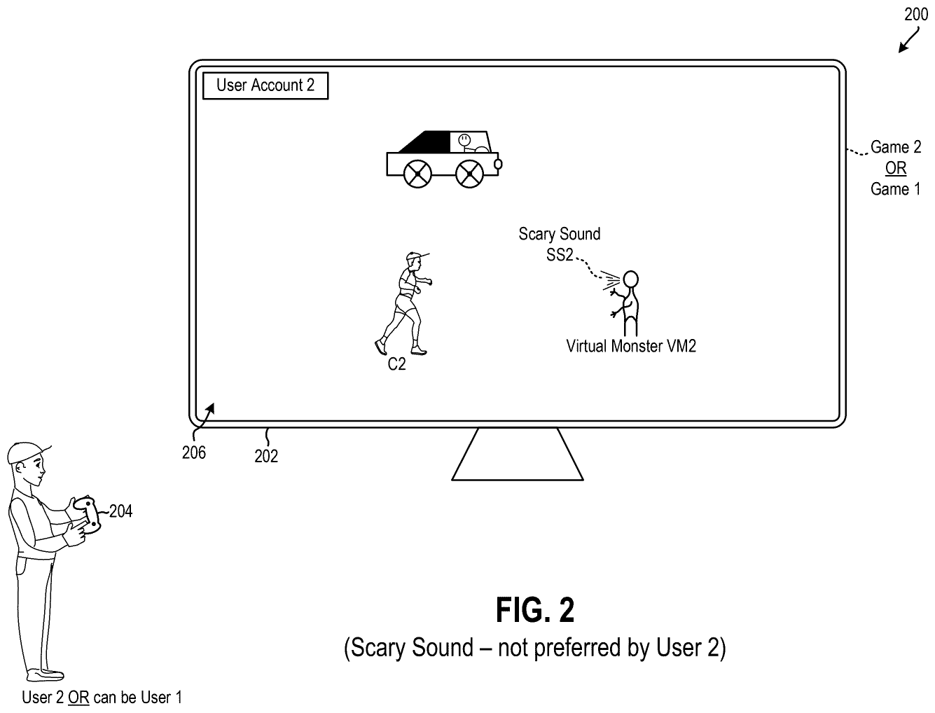

FIG. 2 is a diagram of an embodiment of a system 200 to illustrate a sound that is not preferred by a user 2 during a play of a game 2. The system 200 includes a display device 202 and an HHC 204. The user 2 uses the HHC 204 to access a computer software program, such as the game 2, from the one or more processors of the server system. For example, the user 2 uses the HHC 204 to log into a user account 2 stored on the server system to access the game 2, which is executed by the one or more processors of the server system to generate data for displaying a virtual scene 206 on the display device 202. The data for displaying the virtual scene 206 is sent from the one or more processors of the server system via the computer network to a client device operated by the user 2 for display of the virtual scene 206 on the display device 202.

The virtual scene 206 includes one or more virtual objects, such as a character C2 and a virtual monster VM2, and a virtual background. Examples of a virtual background include a vehicle, such as a car or a truck or an airplane. The character C2 is controlled by the user 2 via the HHC 204. In the virtual scene 206, the virtual monster VM2 makes a sound, such as a scary sound or a roaring sound or a screeching sound or a high pitch sound or a high frequency sound, that is not preferred to be heard by the user 2. For example, the user 2 is bothered by or annoyed by or scared of the sound from the virtual monster VM2.

In an embodiment, instead of the user 2 accessing the game 2 via the user account 2, the user 2 accesses the game 1 via the user account 2. The one or more processors of the server system control the display device 202 to display the virtual scene 206 when the game 1 is accessed.

In one embodiment, instead of the user 2 accessing the game 2 via the user account 2, the user 1 accesses the game 2 via the user account 1. The one or more processors of the server system control the display device 102 (FIG. 1) to display the virtual scene 206 when the game 2 is accessed.

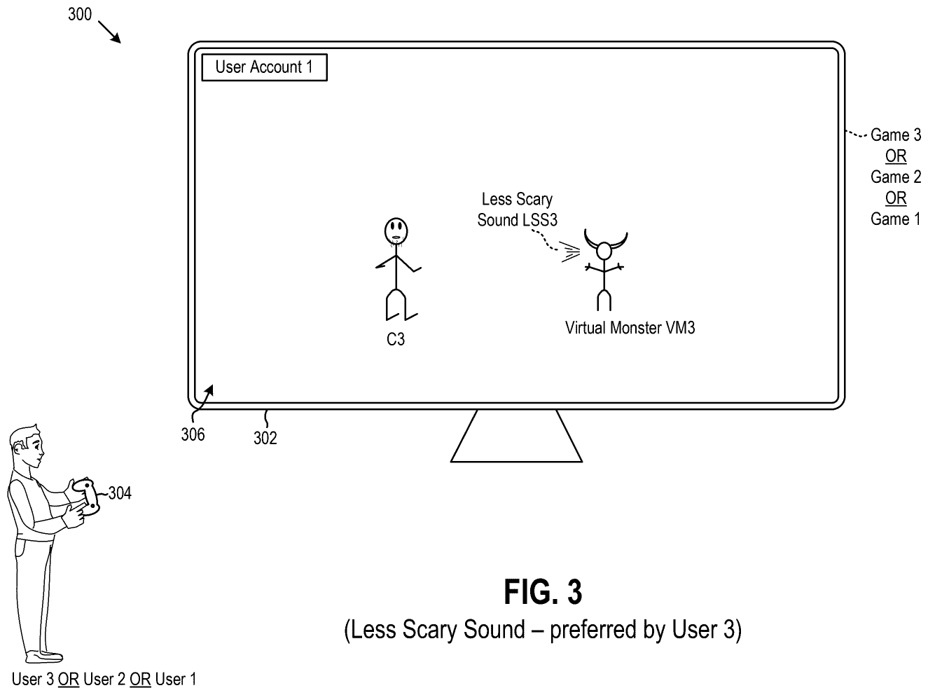

FIG. 3 is a diagram of an embodiment of a system 300 to illustrate a sound that is preferred by a user 3 during a play of a game 3. The system 300 includes a display device 302 and an HHC 304. The user 3 uses the HHC 304 to access the game 3 from the one or more processors of the server system. For example, the user 3 uses the HHC 304 to log into the user account 3 stored on one or more memory devices of the server system to access a virtual scene 306 displayed on the display device 302. Data for displaying the virtual scene 306 is generated by the one or more processors of the server system by execution of the computer software program of the game 3. The data for displaying the virtual scene 306 is sent from the one or more processors of the server system via the computer network to a client device operated by the user 3 for display of the virtual scene 306 on the display device 302.

The virtual scene 302 includes one or more virtual objects, such as a character C3 and the virtual monster VM3, and a virtual background. In the virtual scene 306, the virtual monster VM3 makes a sound, such as a less scary sound or a talking sound or a pleasant sound or a soothing sound or a low pitch sound or a low frequency sound, that is preferred to be heard by the user 3. For example, the user 3 is not bothered by or annoyed by or scared of the sound output from the virtual monster VM3.

In one embodiment, instead of the user 3 accessing the game 3, the user 1 accesses the game 3 via the user account 1 and the HHC 104 (FIG. 1) and the virtual scene 306 is displayed on the display device 102 (FIG. 1) or the user 2 accesses the game 3 via the user account 2 and the HHC 204 (FIG. 2) and the virtual scene 206 is displayed on the display device 202 (FIG. 2).

In an embodiment, instead of the user 3 accessing the game 3, the user 3 accesses the game 1 (FIG. 1) via the user account 3 and the HHC 304 and the virtual scene 106 (FIG. 1) is displayed on the display device 302 or accesses the game 2 (FIG. 2) via the user account 3 and the HHC 304 and the virtual scene 206 (FIG. 2) is displayed on the display device 302.

It should further be noted that the less scary sound LSS3 is less scary compared to the scary sounds SS1 and SS2.

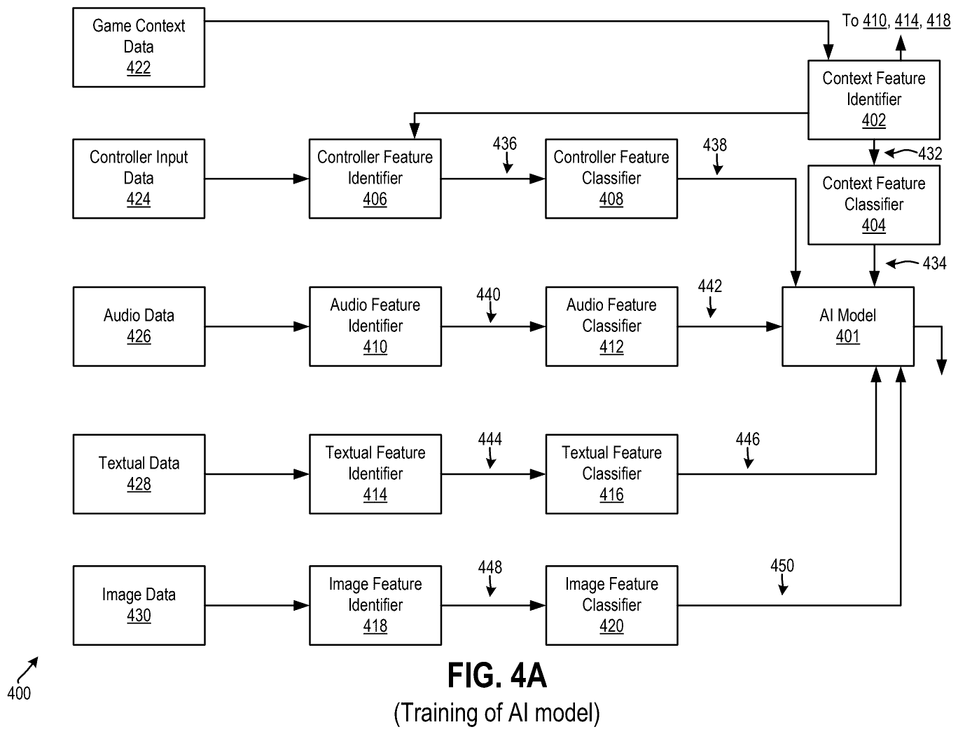

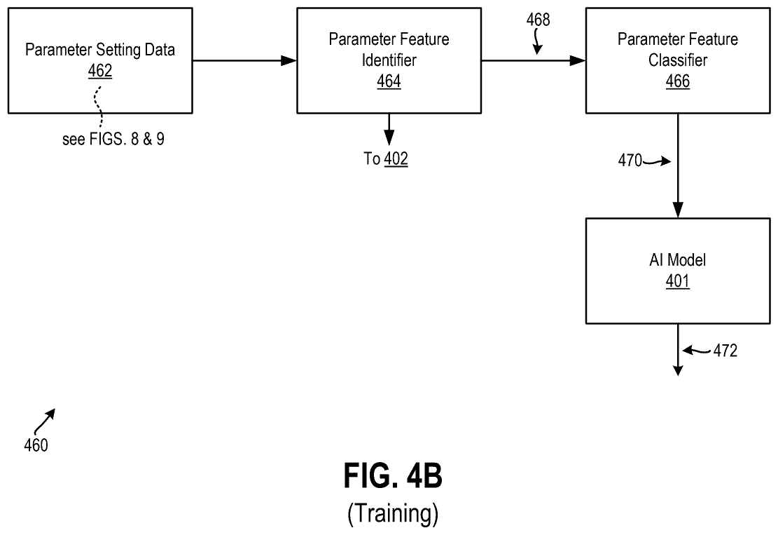

FIG. 4A is a diagram of an embodiment of a system 400 to illustrate training of an artificial intelligence (AI) model 401 based on preferences of one or more users, such as the users 1, 2, and 3, during play of one or more games, such as the games 1, 2, and 3. The system 400 includes a context feature identifier 402, a context feature classifier 404, a controller feature identifier 406, a controller feature classifier 408, an audio feature identifier 410, an audio feature classifier 412, a textual feature identifier 414, a textual feature classifier 416, an image feature identifier 418, and an image feature classifier 420. As an example, each of the context feature identifier 402, the context feature classifier 404, the controller feature identifier 406, the controller feature classifier 408, the audio feature identifier 410, the audio feature classifier 412, the textual feature identifier 414, the textual feature classifier 416, the image feature identifier 418, the image feature classifier 420, and the AI model 401 is implemented as hardware or software or a combination thereof. Examples of the hardware include the one or more processors and the one or more memory devices of one or more servers of the server system. As another example, the hardware includes an integrated circuit include an application specific integrated circuit (ASIC) and a programmable logic device (PLD). Examples of the software include a computer software program or a portion of a computer software program. To illustrate, each of the context feature identifier 402, the context feature classifier 404, the controller feature identifier 406, the controller feature classifier 408, the audio feature identifier 410, the audio feature classifier 412, the textual feature identifier 414, the textual feature classifier 416, the image feature identifier 418, the image feature classifier 420, and the AI model 401 is a separate integrated circuit. To further illustrate, the context feature identifier 402 is a first integrated circuit and the AI model 401 is a second integrated circuit. As another illustration, the context feature identifier 402 is a first computer program executed by a first processor of a first server and the AI model 401 is a second computer program executed by a second processor of a second server.

The system 400 further includes game context data 422, controller input data 424, audio data 426, textual data 428, and image data 430. Examples of the game context data 422 include data identifying a virtual object and a virtual background of a virtual scene, audio data output from the virtual object, audio data output from the virtual background, a time at which the audio data is output from the virtual object, and a time at which the audio data is output from the virtual object. To illustrate, the game context data 422 identifies the virtual monster VM1 (FIG. 1) and audio data of the scary sound SS1 output from the virtual monster VM1 in the virtual scene 106. Also, in the illustration, the game context data 422 includes a time at which the virtual monster VM1 starts or a time at which the virtual monster VM1 ends outputting the scary sound SS1 or a combination thereof. The game context data 422 includes a time period that occurs between the start and end times. The game context data 422 includes a movement of the character C1 after the scary sound SS1 is output and a time of occurrence of the movement. As another illustration, the game context data 422 identifies the virtual monster VM2 (FIG. 2) and audio data of the scary sound SS2 output from the virtual monster VM2 in the virtual scene 206. Also, in the illustration, the game context data 422 includes a time at which the virtual monster VM2 starts or a time at which the virtual monster VM2 ends outputting the scary sound SS2 or a combination thereof. The game context data 422 includes a time period that occurs between the start and end times. The game context data 422 includes a movement of the character C2 after the scary sound SS2 is output and a time of occurrence of the movement. As another illustration, the game context data 422 identifies the virtual monster VM3 (FIG. 3) and audio data of the less scary sound LSS3 output from the virtual monster VM3 in the virtual scene 306. Also, in the illustration, the game context data 422 includes a time at which the virtual monster VM3 starts or a time at which the virtual monster VM3 ends outputting the less scary sound LSS3 or a combination thereof. The game context data 422 includes a time period that occurs between the start and end times. The game context data 422 includes a movement of the character C3 after the less scary sound LSS3 is output and a time of occurrence of the movement.

It should be noted that a time at which a virtual object starts outputting a sound in a virtual scene is sometimes referred to herein as a start time. Also, a time at which a virtual object ends outputting a sound in a virtual scene is sometimes referred to herein as an end time.

Examples of audio data of a sound include one or more frequencies and one or more amplitudes of the sound. To illustrate, a statistical amplitude of the scary sound SS1 is different from a statistical amplitude of the scary sound SS2 and from a statistical amplitude of the less scary sound LSS3. The statistical amplitude of the scary sound SS1 is a statistical value, such as an average or mean, of the amplitudes of the scary sound SS1, the statistical amplitude of the scary sound SS2 is a statistical value, such as an average or mean, of the amplitudes of the scary sound SS2, and the statistical amplitude of the less scary sound LSS3 is a statistical value, such as an average or mean, of the frequencies of the less scary sound LSS3. As another illustration, a statistical frequency of the scary sound SS1 is different from a statistical frequency of the scary sound SS2 and from a statistical frequency of the less scary sound LSS3. The statistical frequency of the scary sound SS1 is a statistical value, such as an average or mean, of the frequencies of the scary sound SS1, the statistical frequency of the scary sound SS2 is a statistical value, such as an average or mean, of the frequencies of the scary sound SS2, and the statistical frequency of the less scary sound LSS3 is a statistical value, such as an average or mean, of the frequencies of the less scary sound LSS3.

An example of the controller input data 424 includes an operation, such as a selection or movement, of a button of an HHC by a user during a play of a game and a time at which the button is operated by the user. To illustrate, the controller input data 424 includes a time at which a button on the HHC 104 is operated, such as selected or moved, by the user 1 immediately after or during the time period in which the virtual monster VM1 makes the scary sound SS1. As another illustration, the controller input data 424 includes a time at which a button on the HHC 204 is operated, such as selected or moved, by the user 2 immediately after or during the time period in which the virtual monster VM2 makes the scary sound SS2. As yet another illustration, the controller input data 424 includes a time at which a button on the HHC 204 is operated, such as selected or moved, by the user 3 immediately after or during the time period in which the virtual monster VM3 makes the less scary sound LSS3.

An example of the audio data 426 includes audio data that is received from a microphone of a client device operated by a user and a time at which the audio data is generated based on a sound uttered by the user. For example, the audio data 426 includes audio data received from a microphone of the HHC 104 and a time at which the audio data is generated by the microphone from a sound uttered by the user 1. The time of generation of the audio data occurs immediately after a time at which the virtual monster VM1 outputs the scary sound SS1. As another example, the audio data 426 includes audio data received from a microphone of the HHC 204 and a time at which the audio data is generated by the microphone from a sound uttered by the user 2. The time of generation of the audio data occurs immediately after a time at which the virtual monster VM2 outputs the scary sound SS2. As yet another example, the audio data 426 includes audio data received from a microphone of the HHC 304 and a time at which the audio data is generated by the microphone from a sound uttered by the user 3. The time of generation of the audio data occurs immediately after a time at which the virtual monster VM3 outputs the less scary sound LSS3.

An example of the textual data 428 includes data that is received from a chat session between a user and another user and the textual data 428 includes a time at which the chat session occurs and a time at which a statement is made by the user via an HHC. The statement is generated by a client device operated by the user when the user operates the HHC. For example, the textual data 428 includes a statement, such as a comment including a series of alphanumeric characters, and a time at which the statement is generated. The statement indicates that the user 1 does not like the scary sound SS1 of the virtual monster VM1. In the example, the statement is generated within a chat session that is a portion of the game 1. To illustrate, the chat session is accessed after the user 1 logs into the user account 1. During the chat session, the user 1 operates the HHC 104 to provide the statement to the one or more processors of the server system via the computer network. As another example, the textual data 428 includes a statement indicating that the user 2 does not like the scary sound SS2 of the virtual monster VM2 and a time at which the statement is generated. In the example, the statement is generated within a chat session that is a portion of the game 2. To illustrate, the chat session is accessed after the user 2 logs into the user account 2. As yet another example, the textual data 428 includes a statement indicating that the user 3 likes the less scary sound LSS3 of the virtual monster VM3 and a time at which the statement is generated. In the example, the statement is generated within a chat session that is a portion of the game 3. To illustrate, the chat session is accessed after the user 3 logs into the user account 3.

An example of the image data 430 includes data, such as data of an image, that is captured by a camera of a client device operated by a user and a time at which the data is captured. For example, the image data 430 is received from a camera of the display device 102 that captures body expressions, such as facial expressions or hand gestures, of the user 1 and a time at which the image data 430 is generated by the camera. The time occurs immediately after the virtual monster VM1 makes the scary sound SS1. The image data identifies the body expressions. As another example, the image data 430 is received from a camera of the display device 202 that captures body expressions, such as facial expressions or hand gestures, of the user 2 and a time at which the data is image data 430 is generated by the camera. The time occurs immediately after the virtual monster VM2 makes the scary sound SS2. The image data identifies the body expressions. As yet another example, the image data 430 is received from a camera of the display device 302 that captures body expressions, such as facial expressions or hand gestures, of the user 3 and a time at which the data is image data 430 is generated by the camera. The time occurs immediately after the virtual monster VM3 makes the less scary sound LSS3. The image data identifies the body expressions.

The game context data 422, the controller input data 424, the audio data 426, the textual data 428, and the image data 430 are stored in one or more databases. For example, the game context data 422, the controller input data for 424, the audio data 426, the textual data 428, and the image data 430 are stored in one or more memory devices of the server system. To illustrate, the game context data 422, the controller input data 424, the audio data 426, and the image data 430 are stored in a first database within the one or more memory devices of the server system that executes the games 1, 2, and 3, and the textual data 428 is stored in a second database within an additional server system that generates a social network session to provide a social network.

The context feature identifier 402, the controller feature identifier 406, the audio feature identifier 410, the textual feature identifier 414, and the image feature identifier 418 are coupled to the one or more databases. Also, the context feature identifier 402 is coupled to the context feature classifier 404, the controller feature identifier 406, the audio feature identifier 410, the textual feature identifier 414, and the image feature identifier 418. Moreover, the context feature classifier 404 is coupled to the controller feature identifier 406, the audio feature identifier 410, the textual feature identifier 414, and the image feature identifier 418. The controller feature identifier 406 is coupled to the controller feature classifier 408, the audio feature identifier 410 is coupled to the audio feature classifier 412, the textual feature identifier 414 is coupled to the textual feature classifier 416, and the image feature identifier 418 is coupled to the image feature classifier 420. The context feature classifier 404, the controller feature classifier 408, the audio feature classifier 412, the textual feature classifier 416, and the image feature classifier 412 are coupled to the AI model 401.

The context feature identifier 402 receives, such as accesses, the game context data 422 from the one or more databases and identifies one or more virtual objects from the game context data 422 and one or more sounds output from the one or more virtual objects to output a context identification signal 432. For example, the context feature identifier 402 identifies that game context data of the virtual scene 106 includes the virtual monster VM1 and that the virtual monster VM1 is outputting the scary sound SS1. To illustrate, the context feature identifier 402 determines from a comparison between a shape, such as an outline, of the virtual monster VM1 with a predetermined shape of a virtual monster that the game context data of the virtual scene 106 includes the virtual monster VM1. To further illustrate, in response to determining that the shape of the virtual monster VM1 is similar, such as the same as, the predetermined shape, the context feature identifier 402 determines that the game context data of the virtual scene 106 includes the virtual monster VM1. In the illustration, the context feature identifier 402 identifies, from the game context data 422, an indication that a sound is output from the virtual monster VM1 to determine that the virtual monster VM1 is outputting the scary sound SS1.

As another example, the context feature identifier 402 identifies that game context data of the virtual scene 206 includes the virtual monster VM2 and that the virtual monster VM2 is outputting the scary sound SS2. To illustrate, the context feature identifier 402 determines from a comparison between a shape, such as an outline, of the virtual monster VM2 with a predetermined shape of a virtual monster that the game context data of the virtual scene 206 includes the virtual monster VM2. In the illustration, the context feature identifier 402 identifies, from the game context data 422, an indication that a sound is output from the virtual monster VM2 to determine that the virtual monster VM2 is outputting the scary sound SS2.

As yet another example, the context feature identifier 402 identifies that game context data of the virtual scene 306 includes the virtual monster VM3 and that the virtual monster VM3 is outputting the less scary sound LSS3. To illustrate, the context feature identifier 402 determines from a comparison between a shape, such as an outline, of the virtual monster VM3 with a predetermined shape of a virtual monster that the game context data of the virtual scene 306 includes the virtual monster VM3. In the illustration, the context feature identifier 402 identifies, from the game context data 422, an indication that a sound is output from the virtual monster VM3 to determine that the virtual monster VM3 is outputting the less scary sound LSS3.

The context identification signal 432 identifies a virtual object, such as a virtual monster, in a virtual scene of a game and a sound, such as amplitudes and frequencies or a statistical amplitude and a statistical frequency, of audio data, output from the virtual object. For example, the context identification signal 432 indicates that the virtual scene 106 includes the virtual monster VM1 and that a sound, such as the scary sound SS1, is output from the virtual monster VM1, the virtual scene 206 includes the virtual monster VM2 and that a sound, such as the scary sound SS2, is output from the virtual monster VM2, and the virtual scene 306 includes the virtual monster VM3 and that a sound, such as the less scary sound LSS3, is output from the virtual monster VM3.

The context feature classifier 404 receives the context identification signal 432 from the context feature identifier 402 and classifies based on the context identification signal 432 whether the one or more sounds output from the one or more virtual objects in a virtual scene are scary or less scary. The context feature classifier 404 classifies that the one or more sounds output from the one or more virtual objects in the virtual scene are scary or less scary to output a context classification signal 434. For example, the context feature identifier 402 parses the audio data output from the virtual monster VM1 to classify frequencies, such as high frequencies, and amplitudes, such as high amplitudes, from the audio data to further classify whether a sound based on the which the audio data is generated is scary or less scary. To illustrate, the context feature identifier 402 determines that the amplitudes of the audio data output from the virtual monster VM1 are high by comparing the amplitudes with a predetermined amplitude and determining that the amplitudes are greater than the predetermined amplitude. In the illustration, the context feature identifier 402 determines that the frequencies of the audio data output from the virtual monster VM1 are high by comparing the frequencies with a predetermined frequency and determining that the frequencies are greater than the predetermined frequency. Further, in the illustration, in response to determining that the amplitudes of the audio data are high and/or the frequencies of the audio data are high, the context feature classifier 404 determines that a sound based on which the audio data is generated is scary. The sound is output from the virtual monster VM1.

As another example, the context feature identifier 402 parses the audio data output from the virtual monster VM2 to classify frequencies, such as high frequencies, and amplitudes, such as high amplitudes, from the audio data to further classify whether a sound based on the which the audio data is generated is scary or less scary. To illustrate, the context feature identifier 402 determines that the amplitudes of the audio data output from the virtual monster VM2 are high by comparing the amplitudes with the predetermined amplitude and determining that the amplitudes are greater than the predetermined amplitude. In the illustration, the context feature identifier 402 determines that the frequencies of the audio data output from the virtual monster VM2 are high by comparing the amplitudes with the predetermined frequency and determining that the frequencies are greater than the predetermined frequency. Further, in the illustration, in response to determining that the amplitudes of the audio data are high and/or the frequencies of the audio data are high, the context feature classifier 404 determines that a sound based on which the audio data is generated is scary. The sound is output from the virtual monster VM2.

As yet another example, the context feature identifier 402 parses the audio data output from the virtual monster VM3 to classify frequencies, such as low frequencies, and amplitudes, such as low amplitudes, from the audio data to further classify whether a sound based on the which the audio data is generated is scary or less scary. To illustrate, the context feature identifier 402 determines that the amplitudes of the audio data output from the virtual monster VM3 are low by comparing the amplitudes with the predetermined amplitude and determining that the amplitudes are lower than the predetermined amplitude. In the illustration, the context feature identifier 402 determines that the frequencies of the audio data output from the virtual monster VM3 are low by comparing the amplitudes with the predetermined frequency and determining that the frequencies are lower than the predetermined frequency. Further, in the illustration, in response to determining that the amplitudes of the audio data are low and/or the frequencies of the audio data are low, the context feature classifier 404 determines that a sound based on which the audio data is generated is less scary. The sound is output from the virtual monster VM3.

The context classification signal 434 includes a classification that a sound output from a virtual object, such as a virtual monster, in a virtual scene of a game is scary or less scary. For example, the context classification signal 432 indicates that that a sound, such as the scary sound SS1, output from a virtual object, such as virtual monster VM1, in the virtual scene 102 is scary, a sound, such as the scary sound SS2, output from a virtual object, such as virtual monster VM2, in the virtual scene 202 is scary, and a sound, such as the less scary sound LSS3, output from a virtual object, such as virtual monster VM3, in the virtual scene 306 is less scary.

The controller feature identifier 406 receives, such as accesses, the controller input data 424 and the game context data 422 from the one or more databases, and determines, from the controller input data 424 and the game context data 422, a variable, such as an identity of a button of an HHC by a user and operation, such as movement or selection or a combination thereof, of the button to output a controller feature identification signal 436. For example, the controller feature identifier 406 identifies that a button, such as an “X” button or a right joystick or a left joystick, on the HHC 104 is selected by the user 1 and that the button is operated, such as moved or selected, by the user 1 to move the character C1 and compares the time at which the button is operated to move the character C1 with the time at which the virtual monster VM1 starts or ends outputting the scary sound SS1 to calculate a difference between the times and to determine that the button is operated immediately after the virtual monster VM1 outputs the scary sound SS1. The controller feature identifier 406 compares the difference with a predetermined time threshold to determine whether the difference exceeds the predetermined time threshold. Upon determining that the difference exceeds the predetermined time threshold, the controller feature identifier 406 determines that it took greater than the predetermined time threshold for the user 1 to select the button immediately after the scary sound SS1 is output.

As another example, the controller feature identifier 406 compares the time at which a button on the HHC 204 to move the character C2 is operated with the time at which the virtual monster VM2 starts or ends outputting the scary sound SS2 to calculate a difference between the times and to determine that the button is operated immediately after the virtual monster VM2 outputs the scary sound SS2. The controller feature identifier 406 compares the difference with the predetermined time threshold to determine whether the difference exceeds the predetermined time threshold. Upon determining that the difference exceeds the predetermined time threshold, the controller feature identifier 406 determines that it took greater than the predetermined time threshold for the user 2 to select the button immediately after the scary sound SS2 is output.

As yet another example, the controller feature identifier 406 compares the time at which a button on the HHC 304 to move the character C3 is operated with the time at which the virtual monster VM3 starts or ends outputting the less scary sound LSS3 to calculate a difference between the times and to determine that the button is operated immediately after the virtual monster VM3 outputs the less scary sound LSS3. The controller feature identifier 406 compares the difference with a predetermined time threshold to determine whether the difference exceeds the predetermined time threshold. Upon determining that the difference does not exceed the predetermined time threshold, the controller feature identifier 406 determines that it took less than the predetermined time threshold for the user 3 to select the button immediately after the less scary sound LSS3 is output.

The controller feature identification signal 436 identifies whether it takes less or greater than the predetermined time threshold for a user to operate an HHC immediately after a sound is output from a virtual object in a virtual scene of a game. For example, the controller feature identification signal 436 identifies that it took greater than the predetermined time threshold for the user 1 to operate the HHC 104 immediately after a sound, such as the scary sound SS1, is output from the virtual monster VM1, that it took greater than the predetermined time threshold for the user 2 to operate the HHC 204 immediately after a sound, such as the scary sound SS2, is output from the virtual monster VM2, and that it took less than the predetermined time threshold for the user 3 to operate the HHC 304 immediately after a sound, such as the less scary sound LSS3, is output from the virtual monster VM3.

The controller feature identifier 406 sends the controller feature identification signal 436 to the controller feature classifier 408. In response to receiving the controller feature identification signal 436, the controller feature classifier 408 determines based on the controller feature identification signal 436 whether a user prefers or does not prefer a sound output from a virtual monster to output a controller feature classification signal 438. For example, the controller feature classifier 408 determines that the user 1 does not prefer the scary sound SS1 output from the virtual monster VM1 upon identifying from the controller feature identification signal 436 that it took greater than the predetermined time threshold for the user 1 to operate the button immediately after the scary sound SS1 is output. As another example, the controller feature classifier 408 determines that the user 2 does not prefer the scary sound SS2 output from the virtual monster VM2 upon identifying from the controller feature identification signal 436 that the it took greater than the predetermined time threshold for the user 2 to operate the button immediately after the scary sound SS2 is output. As yet another example, the controller feature classifier 408 determines that the user 3 prefers the less scary sound LSS3 output from the virtual monster VM3 upon identifying from the controller feature identification signal 436 that the it took less than the predetermined time threshold for the user 3 to operate the button immediately after the less scary sound LSS3 is output.

The controller feature classification signal 438 includes a preference of a user indicating whether a sound output from a virtual object in a virtual scene of a game is scary or less scary. For example, the controller feature classification signal 438 indicates that the user 1 does not prefer the scary sound SS1, the user 2 does not prefer the scary sound SS2, and the user 3 prefers the less scary sound LSS3.

The audio feature identifier 410 receives, such as accesses, the audio data 426 and the game context data 422 from the one or more databases, and determines from the audio data 426 and the game context data 422 whether a voice of a user is normal immediately after a time at which a virtual object, such as a virtual monster, outputs a sound, such as a scary sound in a game. The determination whether the voice of the user is normal is made to determine a type of an emotion of the user towards the sound output from the virtual object in the game. The determination whether the voice of the user is normal or not occurs to output an audio feature identification signal 440. For example, audio data from sounds that are uttered by the user 1 is captured by the microphone of the client device operated by the user 1. The audio feature identifier 410 determines whether a difference between a time at which the audio data is generated and a time at which the virtual monster VM1 outputs the scary sound SS1 is less than a preset time threshold. Upon determining that the difference is less than the preset time threshold, the audio feature identifier 410 parses the audio data to identify frequencies and amplitudes from the audio data. The audio feature identifier 410 determines that the frequencies of the audio data generated from sounds output from the user 1 are high by comparing the frequencies with a preset frequency and determines that the amplitudes of the audio data generated from sounds output from the user 1 are high by comparing the amplitudes with a preset amplitude. In response to determining that the amplitudes are greater than the preset amplitude and the frequencies are greater than the preset frequencies, the audio feature identifier 410 identifies that the sounds uttered by the user 1 are not normal. As another example, in the same manner in which the audio feature identifier 410 identifies that the sounds uttered by the user 1 are not normal, the audio feature identifier 410 identifies that the sounds uttered by the user 2 immediately after the virtual monster VM2 outputs the scary sound SS2 are not normal.

As yet another example, audio data is generated from sounds that are uttered by the user 3. The audio data from sounds that are uttered by the user 3 is captured by the microphone of the client device operated by the user 3. The audio feature identifier 410 determines whether a difference between a time at which the audio data is generated and a time at which the virtual monster VM3 outputs the less scary sound LSS3 is less than the preset time threshold. Upon determining that the difference is less than the preset time threshold, the audio feature identifier 410 parses the audio data to identify frequencies and amplitudes from the audio data. The audio feature identifier 410 determines that the frequencies of the audio data generated from the sounds output from the user 3 are low by comparing the frequencies with the preset frequency and determining that the frequencies are less than the preset frequency and determines that the amplitudes of the audio data generated from sounds output from the user 3 are low by comparing the amplitudes with the preset amplitude and determining that the amplitudes are less than the preset amplitude. In response to determining that the amplitudes are less than the preset amplitude and the frequencies are less than the preset frequencies, the audio feature identifier 410 identifies that the sounds uttered by the user 3 are normal.

The audio feature identification signal 440 indicates whether a sound uttered by a user immediately after a time at which a virtual object, such as a virtual monster, in a virtual scene of a game outputs a sound is normal or not. For example, the audio feature identification signal 440 identifies that the sound uttered by the user 1 immediately after the time at which the virtual monster VM1 outputs the scary sound SS1 is not normal, that the sound uttered by the user 2 immediately after the time at which the virtual monster VM2 outputs the scary sound SS2 is not normal, and that the sound uttered by the user 3 immediately after the time at which the virtual monster VM3 outputs the less scary sound LSS3 is normal.

A normal sound from a user is an example of a first type of emotion of the user and a sound that is not normal is an example of a second type of emotion of the user. The second type is different from the first type. The first type of emotion indicates that the user prefers to hear the sound and the second type of emotion indicates that the user does not prefer to hear the sound.

The audio feature identifier 410 sends the audio feature identification signal 440 to the audio feature classifier 412. Upon receiving the audio feature identification signal 440, the audio feature classifier 412 classifies whether a user prefers to hear a sound that is output from a virtual object, such as a virtual monster, in a virtual scene of a game. The classification is performed by the audio feature classifier 412 to output an audio feature classification signal 442. For example, the audio feature classifier 412 classifies, such as determines, that the user 1 does not prefer to hear the scary sound SS1 in response to identifying from the audio feature identification signal 440 that the sound uttered by the user 1 is not normal. As another example, the audio feature classifier 412 classifies, such as determines, that the user 2 does not prefer to hear the scary sound SS2 in response to identifying from the audio feature identification signal 440 that the sound uttered by the user 2 is not normal. As yet another example, the audio feature classifier 412 classifies, such as determines, that the user 3 prefers to hear the less scary sound LSS3 in response to identifying from the audio feature identification signal 440 that the sound uttered by the user 3 is normal.

The audio feature classification signal 442 indicates whether a user prefers to hear a sound, such as a scary sound or a less scary sound, that is output from a virtual object, such as a virtual monster, in a virtual scene of a game. For example, the audio feature classification signal 442 classifies that the user 1 does not prefer to hear the scary sound SS1, the user 2 does not prefer to hear the scary sound SS2, and the user 3 prefers to hear the less scary sound LSS3.

The textual feature identifier 414 receives, such as accesses, the textual data 428 and the game context data 422 from the one or more databases, and identifies, from the textual data 428 and the game context data 422, meanings of the textual data 428 to output a textual feature identification signal 444. For example, the textual feature identifier 414 accesses a statement made by the user 1 within a chat session regarding the scary sound SS1. To illustrate, the statement includes a comment that “I do not like the sound of the virtual monster VM1 in the game 1”. The textual feature identifier 414 accesses an online dictionary to identify meanings of the comment and determines that the comment indicates that the user 1 does not like the scary sound SS1. The textual feature identifier 414 identifies that the comment is regarding the scary sound SS1 based on the time at which the scary sound SS1 is output and the time at which the comment is made. To further illustrate, the textual feature identifier 414 determines whether a time difference between the time at which the comment is made and the scary sound SS1 is output is less than a prearranged time threshold. Upon determining so, the textual feature identifier 414 determines that the comment is regarding the scary sound SS1. In the illustration, the textual feature identifier 414 accesses the time at which the scary sound SS1 is output from the game context data 422 or the context feature identifier 432 or the time is sent from the context feature identifier 432 to the textual feature identifier 414. As another example, in the same manner in which it is determined that the user 1 does not like the scary sound SS1 based on the chat session having statements made by the user 1 describing a play of the game 1, the textual feature identifier 414 determines that the user 2 does not like the scary sound SS2. To illustrate, the textual feature identifier 414 determines that the user 2 does not like the scary sound SS2 based on a chat session having statements made by the user 2 describing a play of the game 2.

As yet another example, the textual feature identifier 414 accesses a statement, such as a comment, regarding the less scary sound LSS3 within a chat session. The statement is made by the user 3. To illustrate, the statement includes that “I like the sound of the virtual monster VM3 in the game 3” and is made by the user 3 by operating the HHC 304 (FIG. 3). The textual feature identifier 414 accesses an online dictionary to identify meanings of the statement and determines that the statement indicates that the user 3 likes the less scary sound LSS3. The textual feature identifier 414 identifies that the statement is regarding the less scary sound LSS3 based on the time at which the less scary sound LSS3 is output and the time at which the statement is made. To further illustrate, the textual feature identifier 414 determines whether a time difference between the time at which the statement is made and the less scary sound LSS3 is output is less than the prearranged time threshold. Upon determining so, the textual feature identifier 414 determines that the statement is regarding the less scary sound LSS3. In the illustration, the textual feature identifier 414 accesses the time at which the less scary sound LSS3 is output from the game context data 422 or the context feature identifier 432 or the time is sent from the context feature identifier 432 to the textual feature identifier 414.

The textual feature identification signal 444 includes a meaning, such as like or dislike, of a statement made by a user during a chat session of a game. For example, the textual feature identification signal 444 includes an indication that the user 1 does not like the scary sound SS1 output from the virtual monster VM1 in the game 1, the user 2 does not like the scary sound SS2 output from the virtual monster VM2 in the game 2, and the user 3 likes the less scary sound LSS3 output from the virtual monster VM3 in the game 3.

The textual feature identifier 414 sends the textual feature identification signal 444 to the textual feature classifier 416. In response to receiving the textual feature identification signal 444 the textual feature classifier 416 classifies, such as determines, whether a user prefers to hear a scary sound that is output from a virtual monster in a game. For example, upon identifying from the textual feature identification signal 444 that the user 1 does not like the scary sound SS1 of the virtual monster VM1 in the game 1, the textual feature classifier 416 determines that the user 1 does not prefer to hear the scary sound SS1. Similarly, as another example, upon identifying from the textual feature identification signal 444 that the user 2 does not like the scary sound SS2 of the virtual monster VM2 in the game 2, the textual feature classifier 416 determines that the user 2 does not prefer to hear the scary sound SS2. Also, as another example, in response to identifying from the textual feature identification signal 444 that the user 3 likes to hear the less scary sound LSS3 of the virtual monster VM3 in the game 3, the textual feature classifier 416 determines that the user 3 prefers to hear the less scary sound LSS3.

The textual feature classification signal 446 is the same as the audio feature classification signal 442 in that the textual feature classification signal 446 indicates whether a user prefers to hear a sound, such as a scary sound or a less scary sound, that is output from a virtual object, such as a virtual monster, in a virtual scene of a game except that the textual feature classification signal 446 is generated based on the textual data 428. For example, the textual feature classification signal 446 classifies, such as indicates or identifies or distinguishes, that the user 1 does not prefer to hear the scary sound SS1, the user 2 does not prefer to hear the scary sound SS2, and the user 3 prefers to hear the less scary sound LSS3.

The image feature identifier 418 receives, such as accesses, from the one or more databases, the image data 430 and the game context data 422, and identifies, from the image data 430 and the game context data 422 one or more body expressions, such as facial expressions or hand gestures or a combination thereof, of one or more of the users 1-3 to output an image feature identification signal 448. For example, the image feature identifier 418 parses image data captured by a camera of a client device operated by the user 1 to identify a contour of a frown expressed by the user 1. To illustrate, the image feature identifier 418 identifies an occurrence of the frown from a color of the frown. Upon determining that the color of the frown is outside a predetermined color range from a color of remaining portion of a forehead of the user 1 in the image data, the image feature identifier 418 identifies the occurrence of the frown. To further illustrate, in response to determining that the color of the frown is different from, such as darker than, a color of remaining portion of a forehead of the user 1 in the image data, the image feature identifier 418 identifies the occurrence of the frown. On the other hand, in response to determining that the color of the forehead of the user 1 is uniform, such as within the predetermined color range, the image feature identifier 418 determines that the frown does not exist in the image data.

Moreover, in the example, the image feature identifier 418 compares a time at which the image data is generated with the time at which the virtual monster VM1 outputs the scary sound SS1 to determine a difference between the times. The image feature identifier 418 accesses the time at which the virtual monster VM1 outputs the scary sound SS1 from the context feature identifier 402. The image feature identifier 418 determines whether a difference between the times is greater than the predetermined time threshold. In response to determining that the time at which the image data is generated is within the predetermined time threshold from the time at which the scary sound SS1 is output from the virtual monster VM1, the image feature identifier 418 identifies the occurrence of the frown from the image data. On the other hand, upon determining that the time at which the image data is generated is outside the predetermined time threshold from the time at which the scary sound SS1 is output from the virtual monster VM1, the image feature identifier 418 does not identify the occurrence of the frown from the image data. Examples of a body expression of a user include a facial expression of the user, an expression of arms of the user, movements of eyes of the user, and a body posture of the user.

As yet another example, the image feature identifier 418 parses image data captured by a camera of a client device operated by the user 3 to identify an existence of or a lack thereof of a contour of a frown expressed by the user 3. To illustrate, in response to determining that the color of the forehead of the user 3 is uniform, such as within the predetermined color range, the image feature identifier 418 determines that the frown does not exist in the image data.

Moreover, in the example, the image feature identifier 418 compares a time at which the image data is generated with the time at which the virtual monster VM3 outputs the less scary sound LSS3 to determine a difference between the times. The image feature identifier 418 accesses the time at which the virtual monster VM3 outputs the less scary sound LSS3 from the context feature identifier 402. The image feature identifier 418 determines whether a difference between the times is greater than the predetermined time threshold. In response to determining that the time at which the image data is generated is within the predetermined time threshold from the time at which the less scary sound LSS3 is output from the virtual monster VM3, the image feature identifier 418 identifies the lack of existence of the frown from the image data. On the other hand, upon determining that the time at which the image data is generated is outside the predetermined time threshold from the time at which the less scary sound LSS3 is output from the virtual monster VM3, the image feature identifier 418 does not identify the lack of occurrence of the frown from the image data.

The image feature identification signal 448 indicates an existence or a lack of existence of a frown of a user in the image data captured by a client device operated by the user. For example, the image feature identification signal 448 indicates that the user 1 frowns immediately, such as within the predetermined time threshold, after the virtual monster VM1 outputs the scary sound SS1 and indicates that the user 3 does not frown immediately, such as within the predetermined time threshold, after the virtual monster VM3 outputs the less scary sound LSS3.

The image feature classifier 420 receives the image feature identification signal 448 from the image feature identifier 418 and classifies, such as determines, whether a user prefers to hear a sound output by a virtual monster in a game to output an image feature classification signal 450. For example, in response to receiving an indication, from the image feature identification signal 448, that the user 1 frowns immediately after the virtual monster VM1 outputs the scary sound SS1, the image feature classifier 420 determines that the user 1 does not prefer to hear the scary sound SS1. Also, as another example, in response to receiving an indication, from the image feature identification signal 448, that the user 3 lacks a frown immediately after the virtual monster VM3 outputs the less scary sound LSS3, the image feature classifier 420 determines that the user 3 prefers to hear the less scary sound LSS3.

The image feature classification signal 450 is the same as the textual feature classification signal 446 in that the image feature classification signal 450 indicates whether a user prefers to hear a sound, such as a scary sound or a less scary sound, that is output from a virtual object, such as a virtual monster, in a virtual scene of a game except that the image feature classification signal 450 is generated based on the image data 430. For example, the image feature classification signal 450 classifies that the user 1 does not prefer to hear the scary sound SS1, the user 2 does not prefer to hear the scary sound SS2, and the user 3 prefers to hear the less scary sound LSS3.

In an embodiment, instead of or in addition to receiving the game context data 422, one or more of the signals 432 and 434 are used by the controller feature identifier 406, the audio feature identifier 410, the textual feature identifier 414, and the image feature identifier 418. For example, the controller feature identifier 406, the audio feature identifier 410, the textual feature identifier 414, or the image feature identifier 418 receives the signals 432 and 434 generated based on the game context data 422 instead of or in addition to receiving the game context data 422.

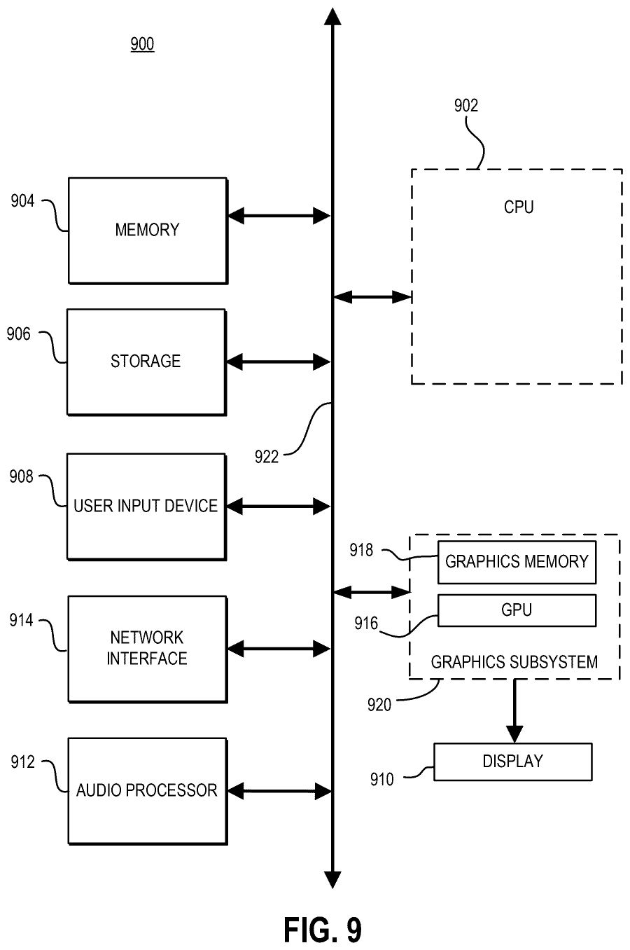

FIG. 4B is a diagram of an embodiment of a system 460 to illustrate training of the AI model 401 based on parameter setting data 462. Examples of the parameter setting data 462 are provided below with reference to FIGS. 8 and 9. For example, the parameter setting data 401 includes an identification of a virtual object in a virtual scene of a game and a level, such as a value or an amount, of a parameter of a sound to be output from the virtual object that is selected by a user via an HHC and via a user account assigned to the user. An example of the parameter is amplitude or frequency or a combination thereof of a sound that is to be output from a virtual object in a virtual scene of a game.

The system 460 includes a parameter feature identifier 464, a parameter feature classifier 466, and the AI model 401. As an example, each of the parameter feature identifier 464 and the parameter feature classifier 466 is hardware or software or a combination thereof.

The parameter feature identifier 464 is coupled to the parameter feature classifier 466, which is coupled to the AI model 401. The parameter feature identifier 464 is also coupled to the context feature identifier 402 and to the context feature classifier 404 (FIG. 4A). The one or more databases store the parameter setting data 462. The parameter feature identifier 464 receives, such as accesses, the parameter setting data 462 and the game context data 422 from the one or more databases, receives, such as accessed, the signals 432 and 434 (FIG. 4A), and identifies from one or more of the parameter setting data 462, the game context data 422, the signal 432, and the signal 434, a virtual object of a virtual scene in a game from the parameter setting data 462. Also, the parameter feature identifier 464 identifies a level of the parameter for the virtual object from one or more of the parameter setting data 462, the game context data 422, the signal 432, and the signal 434 to output a parameter feature identification signal 468.

The parameter feature identification signal 468 includes an identification of a virtual object in a virtual scene of a game and a level of a parameter to be output from the virtual object. The parameter feature identifier 464 sends the parameter feature identification signal 468 to the parameter feature classifier 466.

Upon receiving the parameter feature identification signal 468, the parameter feature classifier 466 classifies, such as determines, whether a user prefers to hear a level of the parameter that is indicated within the parameter feature identification signal 468 and that is to be output from a virtual object in a virtual scene. For example, in response to determining that the level of the parameter of the scary sound SS1 to be output from a virtual object, such as the virtual monster VM1, is less than a predetermined perimeter threshold, the parameter feature classifier 466 determines that the user 1 who identifies the level via the user account 1 does not prefer to hear the scary sound SS1. On the other hand, in response to determining that the level of the parameter of the less scary sound LSS3 is greater than the predetermined perimeter threshold, the parameter feature classifier 466 determines that the user 3 who identifies the level via the user account 3 prefers to hear the less scary sound LSS3.

The parameter feature classifier 466 performs the classification to generate a parameter feature classification signal 470. The parameter feature classification signal 470 is the same as the image feature classification signal 450 in that the parameter feature classification signal 470 indicates whether a user prefers to hear a sound, such as a scary sound or a less scary sound, that is output from a virtual object, such as a virtual monster, in a virtual scene of a game except that the parameter feature classification signal 470 is generated based on the parameter setting data 462. For example, the parameter feature classification signal 470 classifies that the user 1 does not prefer to hear the scary sound SS1, the user 2 does not prefer to hear the scary sound SS2, and the user 3 prefers to hear the less scary sound LSS3.

The context feature classifier 404 sends the context feature classification signal 434 to the AI model 401, the controller feature classifier 408 sends the controller feature classification signal 438 to the AI model 401, the audio feature classifier 412 sends the audio feature classification signal 442 to the AI model 401, the textual feature classifier 416 sends the textual feature classification signal 446 to the AI model 401, the image feature classifier 420 sends the image feature classification signal 450 to the AI model 401, and/or the parameter feature classifier 466 sends the parameter feature classification signal 470 to the AI model 401 to train the AI model 401. In response to receiving the context feature classification signal 432 indicating that the scary sound SS1 is scary and determining that a majority, such as at least three out of five, of the classification signals 438, 442, 446, 450, and 470 indicate that the user 1 does not prefer to hear the scary sound SS1, the AI model 401 generates an output 472 indicating that there is a high probability, such as greater than 50%, that the user 1 does not prefer to hear the scary sound SS1. On the other hand, in response to receiving the context feature classification signal 432 indicating that the scary sound SS1 is scary and determining that a minority, such as two out of five, of the classification signals 438, 442, 446, 450, and 470 indicate that the user 1 does not prefer to hear the scary sound SS1, the AI model 401 generates an output 472 indicating that there is a low probability, such as less than 50%, that the user 1 does not prefer to hear the scary sound SS1.

Also, in response to receiving the context feature classification signal 432 indicating that the less scary sound LSS3 is less scary and determining that a majority, such as at least three out of five, of the classification signals 438, 442, 446, 450, and 470 indicate that the user 3 prefers to hear the less scary sound LSS3, the AI model 401 generates the output 472 indicating that there is a high probability, such as greater than 50%, that the user 3 prefers to hear the less scary sound LSS3.

It should be noted that although the embodiments, described herein, are described with reference to a virtual object in a virtual scene, the embodiments apply equal to another virtual asset, such as a virtual background, of the virtual scene.

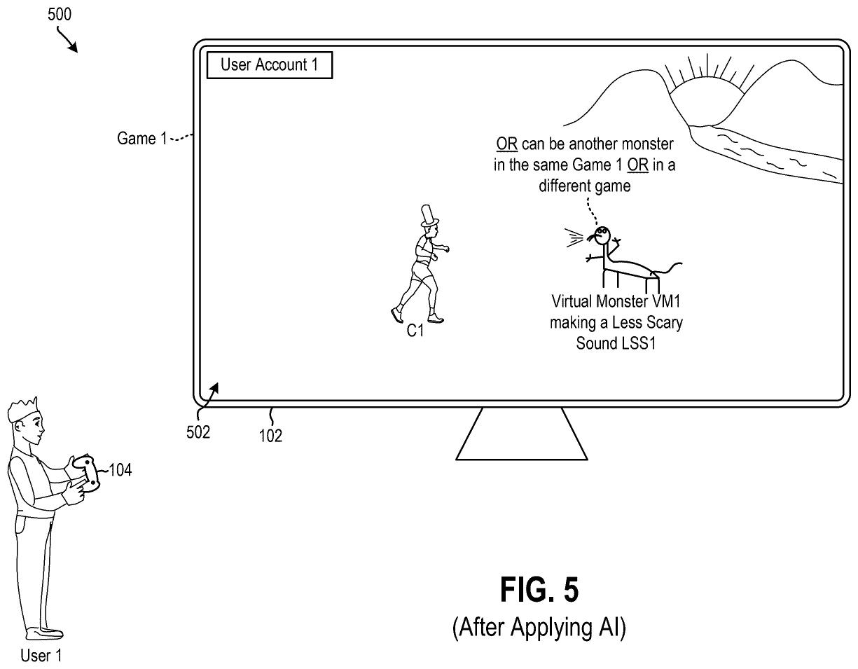

FIG. 5 is a diagram of an embodiment of a system 500 to illustrate a virtual scene 502 in which the virtual monster VM1 outputs a less scary sound LSS1, such as the less scary sound LSS3 or another less scary sound, after the AI model 401 (FIG. 4A) is trained. The system 500 includes the display device 102 and the HHC 104 that is held by the user 1. The AI model 401 provides the output 472 to the one or more processors of the server system that execute the computer software program of the game 1. The output 472 is provided to indicate to the one or more processors of the server system the high probability that the user 1 does not prefer to hear the scary sound SS1 from the virtual monster VM1.

Upon receiving the output 472, the one or more processors of the server system control a sound to be output from the virtual monster VM1 to be the less scary sound LSS1 instead of the scary sound SS1. For example, the user 1 operates the HHC 104 to access data for displaying the virtual scene 502 of the game 1 via the user account 1 from the one or more processors of the server system after the user 1 accesses data for displaying the virtual scene 106 (FIG. 1). To illustrate, the data for displaying virtual scene 502 is accessed during the same or a different game session in which the data for displaying virtual scene 106 is accessed. To further illustrate, a first game session begins when a user logs into a user account assigned to the user and ends when the user uses an HHC to log out of the user account. In the further illustration, when a second game session is accessed after the first game session ends, the second game session is different from the first game session.

After the data for displaying the virtual scene 106 is accessed and before the data for displaying the virtual scene 502 is accessed, the one or more processors of the server system modify the computer program of the game 1 to output the less scary sound LSS1 from the virtual monster VM1 instead of the scary sound SS1. When the one or more processors of the server system control the virtual monster VM1 to output a sound in the virtual scene 501, the sound is the less scary sound LSS1 and not the scary sound SS1.

In an embodiment, the virtual scene 502 is of the game 2 or the game 3.

In one embodiment, the one or more processors control another virtual monster (not shown) instead of the virtual monster VM1 in the virtual scene 508 to output the less scary sound LSS1.

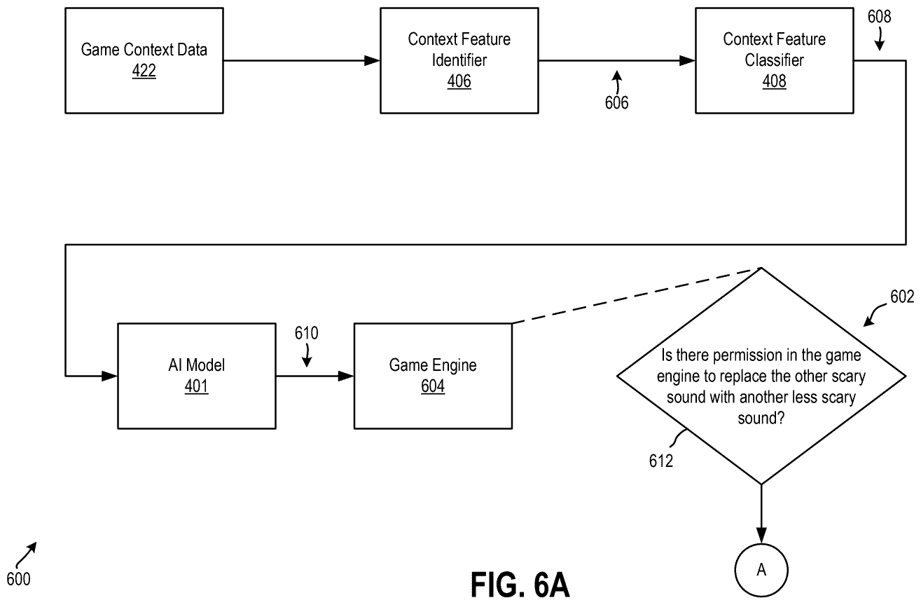

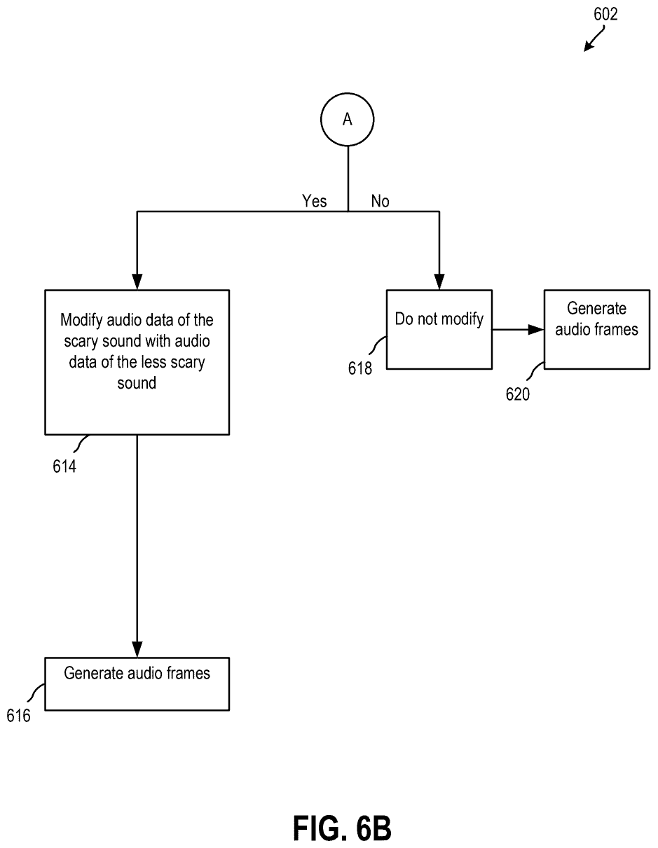

FIG. 6A is a diagram of an embodiment of a system 600 to illustrate a method 602 for replacing a scary sound with a less scary sound. FIG. 6B is a diagram of a flowchart of the method 602. The method 602 is executed by the one or more processors of the server system. The system 600 includes the game context data 424, the context feature identifier 406, the context feature classifier, 408, the AI model 401, and a game engine 604. An example of the game engine 604 is a computer software program of a game, such as the game 1 or 2 or 3. To illustrate, the game engine 604 includes a physics engine, a graphics rendering engine, a sound engine, and an audio engine. The AI model 401 is coupled to the game engine 604. The game engine 604 is executed by the one or more processors of the server system to generate a virtual scene of the game, such as the game 1 or 2 or 3.

In the method 602, the context feature identifier 406 identifies, such as determines, from the game context data 422, whether a virtual monster, such as the virtual monster VM1, is about to output a sound SSy, such as the scary sound SS1, in a game, such as the game 1, during the same or a different game session that a game session used to access a virtual scene, such as the virtual scene 106 (FIG. 1) or 206 (FIG. 2). For example, the user 1 uses the HHC 104 (FIG. 1) to access the virtual scene 502 (FIG. 5) of a game session of the game 1 via the user account 1. The game session is the same as that or different from a game session in which the virtual scene 106 is accessed via the user account 1. When the game session for accessing the virtual scene 502 is different from the game session for accessing the virtual scene 106, the user 1 uses the HHC 104 to log out of the user account 1 and log back into the user account 1. On the other hand, when the game session for accessing the virtual scene 502 is the same as the game session for accessing the virtual scene 106, the user 1 does not log out of the user account 1 between the game sessions. In the example, the game context data 422 includes an indication whether the virtual monster VM1 is about to output the sound SSy and an identification of the sound SSy. To illustrate, the identification of the sound SSy includes amplitudes of the sound SSy and frequencies of the sound SSy. As another example, the game context data 422 identifies the virtual monster and includes audio data for outputting the scary sound SSy from the virtual monster VM in the virtual scene.

Upon determining that the virtual monster is about to output the sound SSy, the context feature identifier 406 generates a context feature identification signal 606 identifying that the virtual monster is about to output the sound SSy and the identification of the sound SSy to be output. The context feature identifier 406 sends the context feature identification signal 606 to the context feature classifier 408.

In response to receiving the context feature identification signal. 606, the context feature classifier 408 determines whether the sound SSy to be output is a scary sound. For example, the context feature classifier 408 compares amplitudes of another sound SSx, such as the scary sound SS1 or SS2 or the less scary sound LSS3, with the amplitudes of the sound SSy. To illustrate, the context feature classifier 408 receives, such as accesses, the amplitudes of the sound SS1 from the context feature identifier 406. Further in the example, the context feature classifier 408 calculates a first statistical amplitude, such as an average or a mean, from the amplitudes of the sound SSx and calculates a second statistical amplitude, such as an average or a mean, from the amplitudes of the scary sound SSy. The context feature classifier 408 compares the first statistical amplitude with the second statistical amplitude to determine whether the first statistical amplitude and the second statistical amplitude are within a predetermined amplitude range from each other. Upon determining that the first statistical amplitude and the second statistical amplitude are within the predetermined amplitude range from each other, the context feature classifier 408 determines that the sound SSy is similar to the sound SSx. On the other hand, upon determining that the first statistical amplitude is outside the predetermined amplitude range from the second statistical amplitude, the context feature classifier 408 determines that the sound SSy is not similar to the sound SSx.

As another example, the context feature classifier 408 compares frequencies of the sound SSx with the frequencies of the sound SSy. To illustrate, the context feature classifier 408 receives, such as accesses, the frequencies of the sound SSx from the context feature identifier 406. Further in the example, the context feature classifier 408 calculates a first statistical frequency, such as an average or a mean, from the frequencies of the scary sound SS1 and calculates a second statistical frequency, such as an average or a mean, from the frequencies of the scary sound SSy. The context feature classifier 408 compares the first statistical frequency with the second statistical frequency to determine whether the first statistical frequency and the second statistical frequency are within a predetermined frequency range from each other. Upon determining that the first statistical frequency and the second statistical frequency are within the predetermined frequency range from each other, the context feature classifier 408 determines that the sound SSy is similar to the sound SSx. On the other hand, upon determining that the first statistical frequency is outside the predetermined frequency range from the second statistical frequency, the context feature classifier 408 determines that the sound SSy is not similar to the sound SSx.

As yet another example, upon determining that the first statistical amplitude and the second statistical amplitude are within the predetermined amplitude range from each other and the first statistical frequency and the second statistical frequency are within the predetermined frequency range from each other, the context feature classifier 408 determines that the sound SSy is similar to the sound SSx. On the other hand, upon determining that the first statistical amplitude and the second statistical amplitude are not within the predetermined amplitude range from each other and the first statistical frequency and the second statistical frequency are not within the predetermined frequency range from each other, the context feature classifier 408 determines that the sound SSy is not similar to the sound SSx.

The context feature classifier 408 generates a context feature classification signal 608 indicating whether the sound SSy is similar to the sound SSx. For example, the context feature classification signal 408 indicates that the sound SSy is similar to the sound SSx or is dissimilar from, such as not similar to, the sound SSx. The context feature classifier 408 sends the context feature classification signal 608 to the AI model 401.

In response to receiving the context feature classification signal 608 indicating that the sound SSy is similar to the sound SSx, the AI model 401 applies the same probability to the sound SSy as that applied to the sound SSx. For example, the AI model 401 outputs a result 610 indicating the high probability that a user, such as the user 1, does not prefer to hear the sound SSy similar to the scary sound SS1 or SS2. The high probability is the same as the high probability that the user 1 does not prefer to hear the scary sound SS1 or the user 2 does not prefer to hear the scary sound SS2. As another example, the AI model 401 outputs the result 610 indicating the low probability that a user, such as the user 1, does not prefer to hear the sound SSy similar to the scary sound SS1 or SS2. The low probability is the same as the low probability that the user 1 does not prefer to hear the scary sound SS1 or the user 2 does not prefer to hear the scary sound SS2. Also, as another example, in response to receiving the context feature classification signal 608 indicating that the sound SSy is similar to the less scary sound LSS3, the AI model 401 outputs the result 610 indicating the same probability for the sound SSy as that applied to the less scary sound LSS3. To illustrate, the AI model 401 outputs the result 610 indicating the high probability that a user, such as the user 1, prefers to hear the sound SSy similar to the less scary sound LSS3.

The AI model 401 sends the result 610 to the game engine 604. In response receiving the result 610 indicating that a user, such as the user 1, does not prefer to hear the sound SS1 or SS2 or prefers to hear the less scary sound LSS3 or a combination thereof, the one or more processors of the server system determine, in an operation 612 of the method 602, whether there is permission from a computer software program of a game to replace the audio data for outputting the sound SSy, such as the scary sound SS1 or another sound similar to the scary sound SS1, with audio data for outputting the less scary sound, such as the LSS3. For example, the one or more processors of the server system parse through a code of the computer software program of the game 1 to determine whether the permission is included within the code.

In response to determining that the permission is provided by the computer software program, the one or more processors of the server system modify, in an operation 614 of the method 600, the audio data to be output as the sound SSy, such as the scary sound SS1 or SS2 or another sound similar to the scary sound SS1 or SS2, to generate modified audio data to be output as the less scary sound LSS1. For example, the one or more processors of the server system adjust the parameter, such as the frequency or the amplitude or a combination thereof, of the audio data of the scary sound SS1 or SS2 to generate the modified audio data of the less scary sound LSS1. By generating the modified audio data of the less scary sound LSS1, the game context of the scary sound SS1 or SS2 is preserved. To illustrate, when the scary sound SS1 or SS2 is not replaced by a different sound, such as a sound of a virtual train or a virtual plane, emanating from a virtual object or a virtual background of a different type from the virtual monster VM1 or VM2, the game context is preserved. To illustrate, the virtual object or the virtual background is of the different type when the virtual object or the virtual background looks and functions differently compared to the virtual monster VM1 or VM2. As another example, the one or more processors of the server system adjust the parameter of the audio data of the scary sound SS1 or SS2 to generate the modified audio data that mutes the scary sound SS1 or SS2. As another example, the one or more processors of the server system modify a three-dimensional location in a virtual scene, such as the virtual scene 106, at which the scary sound SS1 or SS2 is output to another location at which the less scary sound LSS1 or the scary sound SS1 or SS2 is to be output. In the example, the less scary sound LSS1 is output at the other location in another virtual scene, such as the virtual scene 502 (FIG. 5), compared to the location at which the scary sound SS1 is output in the virtual scene 106. As yet another example, one or more other sounds that are associated with the scary sound SS1 or SS2 that is modified are modified. To illustrate, the one or more processors of the server system modify audio data of the one or more other sounds, such as yawning sound or snorting sound, to be output from the virtual monster VM1 or another virtual object in the scene 106 in the game 1 after the scary sound SS1 is output. The one or more other sounds are to be output in a game as indicated within the computer software program of the game.

Further, in an operation 616 of the method 602, the one or more processors of the server system generate modified audio frames based the modified audio data. For example, the one or more processors of the server system generate the modified audio frames having the modified audio data. The one more processors of the server system send the modified audio frames via the computer network to a client device, such as the display device 102 or the HHC 104 (FIG. 1), that is operated by a user, such as the user 1. In response to receiving the modified audio frames, the client device operated by the user outputs the less scary sound. For example, a processor of the client device controls a speaker of the client device to output the less scary sound LSS1 or no sound.

On the other hand, in response to determining that the permission is not provided by the computer software program, the one or more processors of the server system does not modify, in an operation 618 of the method 600, the audio data to be output as the sound SSy, such as the scary sound SS1 or SS2 or another sound similar to the scary sound SS1 or SS2. Further, in an operation 620 of the method 602, the one or more processors of the server system generate audio frames based on the audio data of the scary sound SS1 or SS2 that is not modified. The one more processors of the server system send the audio frames via the computer network to the client device, such as the display device 102 or the HHC 104, that is operated by a user, such as the user 1. In response to receiving the audio frames, the client device operated by the user outputs the scary sound. For example, a processor of the client device controls a speaker of the client device to output the scary sound SS1.

Also, in response receiving the result 610 indicating that a user, such as the user 1, prefers to hear the sound SSy similar to the scary sound SS1 or SS2, the one or more processors perform the operations 618 and 620.

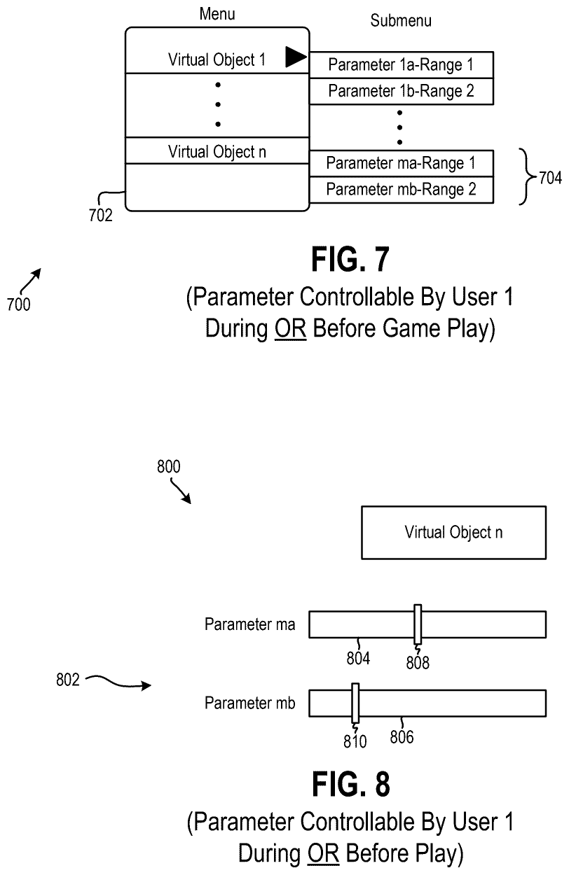

FIG. 7 is a diagram of an embodiment of a system 700 to illustrate a selection of the parameter and a range of the parameter for a virtual object by a user. Upon accessing a game session of a game, such as the game 1 or 2 or 3, a user, such as the user 1 or 2 or 3, uses an HHC to access a menu 702 within the game. Data for displaying the menu 702 is generated by the one or more processors of the server system and the menu 702 is displayed on a client device operated by the user. For example, the menu 702 is displayed on the display device 102 (FIG. 1) or 202 (FIG. 2) or 302 (FIG. 3).

The menu 702 lists virtual objects 1 through n within the game, where n is a positive integer. Examples of the virtual object n include the virtual monster VM1 (FIG. 1) or VM2 (FIG. 2) or VM3 (FIG. 3). In response receiving a selection via the HHC of the virtual object n, the one or more processors of the server system generate data for displaying a submenu 704. The submenu 704 includes a parameter ma of a sound to be output from the virtual object m, and another parameter mb of the sound to be output from the virtual object m. The submenu 704 also includes a range 1 of the parameter ma and a range 2 of the parameter mb. An example of the parameter ma is frequency and an example of the parameter mb is amplitude. The user operates the HHC to select the range 1 of the parameter ma to output a selected range of the parameter ma or to modify the range 1 of the parameter ma to output a modified range of the parameter ma or to select the range 2 of the parameter mb to output a selected range of the parameter mb or to modify the range 2 of the parameter mb to output a modified range of the parameter mb. The selected range of the parameter ma or the modified range of the parameter ma is an example of a level, such as a value, of the parameter of the parameter setting data 462 (FIG. 4B). To illustrate, the selected range of the parameter ma or the modified range of the parameter ma is includes a single value of the parameter of the parameter setting data 462. The selected range of the parameter mb or the modified range of the parameter mb is an example of a level, such as a value, of the parameter of the parameter setting data 462. To illustrate, the selected range of the parameter of the parameter mb or the modified range of the parameter mb is includes a single value of the parameter setting data 462.

The one or more processors of the server system execute the computer software program of the game based on the selected range of the parameter ma or the modified range of the parameter ma and the selected range of the parameter mb or the modified range of the parameter mb. For example, the one or more processors of the server system execute the computer software program of the game to control the virtual object VM1 to output a sound according to the selected range of the parameter ma or the modified range of the parameter ma and the selected range of the parameter mb or the modified range of the parameter mb.

FIG. 8 is a diagram of an embodiment of a system 800 to illustrate an analog slider to select a level of the parameter of a sound to be output by a virtual object in a game. The system 800 includes a menu 802. Upon accessing a game session of the game, such as the game 1 or 2 or 3, a user, such as the user 1 or 2 or 3, uses an HHC to access the menu 802 within the game. Data for displaying the menu 802 is generated by the one or more processors of the server system and the menu 802 is displayed on a client device operated by the user. For example, the menu 802 is displayed on the display device 102 (FIG. 1) or 202 (FIG. 2) or 302 (FIG. 3).

The menu 802 includes a sliding scale 804 to select a value of the parameter ma of a sound to be output by the virtual object n and another sliding scale 806 to select a value of the parameter mb of the sound to be output by the virtual object n. The user operates the HHC to slide a slider 808 on the sliding scale 804 to modify the value of the parameter ma to output a modified value of the parameter ma. The user operates the HHC to slide a slider 810 on the sliding scale 806 to modify the value of the parameter mb to output a modified value of the parameter mb. The one or more processors of the server system execute the computer software program of the game based on the modified value of the parameter ma or the modified value of the parameter mb or a combination thereof. For example, the one or more processors of the server system execute the computer software program of the game to control the virtual object VM1 to output a sound according to the modified value of the parameter ma or the modified value of the parameter mb or a combination thereof.

FIG. 9 illustrates components of an example device 900, such as a client device or a server system, described herein, that can be used to perform aspects of the various embodiments of the present disclosure. This block diagram illustrates the device 900 that can incorporate or can be a personal computer, a smart phone, a video game console, a personal digital assistant, a server or other digital device, suitable for practicing an embodiment of the disclosure. The device 900 includes a CPU 902 for running software applications and optionally an operating system. The CPU 902 includes one or more homogeneous or heterogeneous processing cores. For example, the CPU 902 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. The device 900 can be a localized to a player, such as a user, described herein, playing a game segment (e.g., game console), or remote from the player (e.g., back-end server processor), or one of many servers using virtualization in a game cloud system for remote streaming of gameplay to clients.

A memory 904 stores applications and data for use by the CPU 902. A storage 906 provides non-volatile storage and other computer readable media for applications and data and may include fixed disk drives, removable disk drives, flash memory devices, compact disc-read only memory (CD-ROM), digital versatile disc-ROM (DVD-ROM), Blu-ray, high definition-digital versatile disc (HD-DVD), or other optical storage devices, as well as signal transmission and storage media. User input devices 908 communicate user inputs from one or more users to the device 900. Examples of the user input devices 908 include keyboards, mouse, joysticks, touch pads, touch screens, still or video recorders/cameras, tracking devices for recognizing gestures, and/or microphones. A network interface 914, such as a network interface controller (NIC), allows the device 900 to communicate with other computer systems via an electronic communications network, and may include wired or wireless communication over local area networks and wide area networks, such as the internet. An audio processor 912 is adapted to generate analog or digital audio output from instructions and/or data provided by the CPU 902, the memory 904, and/or data storage 906. The components of device 900, including the CPU 902, the memory 904, the data storage 906, the user input devices 908, the network interface 914, and an audio processor 912 are connected via a data bus 922.

A graphics subsystem 920 is further connected with the data bus 922 and the components of the device 900. The graphics subsystem 920 includes a graphics processing unit (GPU) 916 and a graphics memory 918. The graphics memory 918 includes a display memory (e.g., a frame buffer) used for storing pixel data for each pixel of an output image. The graphics memory 918 can be integrated in the same device as the GPU 916, connected as a separate device with the GPU 916, and/or implemented within the memory 904. Pixel data can be provided to the graphics memory 918 directly from the CPU 902. Alternatively, the CPU 902 provides the GPU 916 with data and/or instructions defining the desired output images, from which the GPU 916 generates the pixel data of one or more output images. The data and/or instructions defining the desired output images can be stored in the memory 904 and/or the graphics memory 918. In an embodiment, the GPU 916 includes three-dimensional (3D) rendering capabilities for generating pixel data for output images from instructions and data defining the geometry, lighting, shading, texturing, motion, and/or camera parameters for a scene. The GPU 916 can further include one or more programmable execution units capable of executing shader programs.

The graphics subsystem 914 periodically outputs pixel data for an image from the graphics memory 918 to be displayed on the display device 910. The display device 910 can be any device capable of displaying visual information in response to a signal from the device 900, including a cathode ray tube (CRT) display, a liquid crystal display (LCD), a plasma display, and an organic light emitting diode (OLED) display. The device 900 can provide the display device 910 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a GPU since it will be doing a large number of relatively simple mathematical operations (e.g., matrix transformations). Other game engine segments that require fewer but more complex operations may be provisioned with a processing entity associated with one or more higher power CPUs.

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and an input/output (I/O) interface. The client device can be a personal computer (PC), a mobile phone, a netbook, a personal digital assistant (PDA), etc. In one embodiment, the network executing on the game server recognizes the type of device used by the client and adjusts the communication method employed. In other cases, client devices use a standard communications method, such as html, to access the application on the game server over the internet. It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller device (in this case, a keyboard and mouse) to inputs which are acceptable for the execution of the video game.

In another example, a user may access the cloud gaming system via a tablet computing device system, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

In an embodiment, although the embodiments described herein apply to one or more games, the embodiments apply equally as well to multimedia contexts of one or more interactive spaces, such as a metaverse.

In one embodiment, the various technical examples can be implemented using a virtual environment via the HMD. The HMD can also be referred to as a virtual reality (VR) headset. As used herein, the term “virtual reality” (VR) generally refers to user interaction with a virtual space/environment that involves viewing the virtual space through the HMD (or a VR headset) in a manner that is responsive in real-time to the movements of the HMD (as controlled by the user) to provide the sensation to the user of being in the virtual space or the metaverse. For example, the user may see a three-dimensional (3D) view of the virtual space when facing in a given direction, and when the user turns to a side and thereby turns the HMD likewise, the view to that side in the virtual space is rendered on the HMD. The HMD can be worn in a manner similar to glasses, goggles, or a helmet, and is configured to display a video game or other metaverse content to the user. The HMD can provide a very immersive experience to the user by virtue of its provision of display mechanisms in close proximity to the user's eyes. Thus, the HMD can provide display regions to each of the user's eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user's interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in said prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on the HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g. tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, compact disc-read only memories (CD-ROMs), CD-recordables (CD-Rs), CD-rewritables (CD-RWs), magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator. In either case, if the video game is represented as a simulation, that simulation is capable of being executed to render interactive content that can be interactively streamed, executed, and/or controlled by user input.

It should be noted that in various embodiments, one or more features of some embodiments described herein are combined with one or more features of one or more of remaining embodiments described herein.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

1. A method for modifying a sound based on user preferences, comprising:
receiving first audio data of a first sound to be output from a first virtual object during a play of a game by a user;
determining, by an artificial intelligence (AI) model, that the first sound is not preferred to be heard by the user;
providing an indication to a game engine that the first sound is not preferred to be heard from the user; and
modifying, by the game engine, the first audio data with second audio data to be output as a second sound preferred to be heard by the user.

2. The method of claim 1, further comprising:
determining whether a permission to modify the first audio data exists, wherein said modifying the first audio data occurs in response to determining that the permission exists.

3. The method of claim 1, further comprising sending the second audio data instead of the first audio data via a computer network to a client device for outputting the second sound.

4. The method of claim 1, further comprising:
receiving, by the AI model, game context data of the game, wherein the game context data identifies the first virtual object and a second virtual object, the first audio data of the first sound output from the first virtual object, and second audio data of a third sound output from the second virtual object;
receiving, by the AI model, controller input data, wherein the controller input data identifies a first set of one or more buttons selected on one or more game controllers or one or more movements of a second set of one or more buttons selected on the one or more game controllers or a combination thereof;
receiving, by the AI model, audio information generated from a voice of the user;
receiving, by the AI model, textual data from one or more user accounts assigned to the user and an additional user;
receiving, by the AI model, image data identifying a body expression from the user and an additional body expression from the additional user; and
receiving, by the AI model, parameter setting data identifying one or more levels of one or more parameters of one or more sounds to be output by the first virtual object and the second virtual object.

5. The method of claim 4, further comprising:
identifying, from the game context data by the AI model, the first virtual object and the second virtual object and the first audio data of the first sound output from the first virtual object and the second audio data of the third sound output from the second virtual object;
identifying, from the controller input data by the AI model, the first set of one or more buttons selected on the one or more game controllers or the one or more movements of the second set of one or more buttons selected on the one or more game controllers or the combination thereof;
identifying, from the audio information by the AI model, an emotion of the user towards the first sound and an additional emotion of the additional user towards the first sound or the third sound output from the second virtual object;
identifying, from the textual data by the AI model, a liking of the user towards the first sound and an additional liking of the additional user towards the first sound or the third sound;
identifying, from the image data by the AI model, the body expression of the user towards the first sound and the additional body expression of the additional user towards the first sound or the third sound; and
identifying, from the parameter setting data by the AI model, a level of a parameter of the first sound and an additional level of the parameter of the third sound.

6. The method of claim 5, further comprising:
classifying, by the AI model, the first sound as scary or less scary and the third sound as scary or less scary;
classifying, by the AI model, a first preference of the user towards the first sound based on the selection of the first set of one or more buttons or the one or more movements of the second set of one or more buttons selected on the one or more game controllers or the combination thereof, wherein the first preference of the user is classified to output a first classification signal;
classifying, by the AI model, a second preference of the user towards the first sound based on the emotion of the user towards the first sound or the additional emotion of the additional user towards the first sound or the third sound output from the second virtual object, wherein the second preference of the user is classified to output a second classification signal;
classifying, by the AI model, a third preference of the user towards the first sound based on the liking of the user towards the first sound or the additional liking of the additional user towards the first sound or the third sound, wherein the third preference of the user is classified to output a third classification signal;
classifying, by the AI model, a fourth preference of the user towards the first sound based on the body expression of the user towards the first sound or the additional body expression of the additional user towards the first sound or the third sound, wherein the fourth preference of the user is classified to output a fourth classification signal; and
classifying, by the AI model, a fifth preference of the user towards the first sound based on the level of the parameter of the first sound and the additional level of the parameter of the third sound, wherein the fifth preference of the user is classified to output a fifth classification signal.

7. The method of claim 6, further comprising training the AI model based on the first classification signal, the second classification signal, the third classification signal, the fourth classification signal, and the fifth classification signal.

8. A server system for modifying a sound based on user preferences, comprising:
a processor configured to:
receive first audio data of a first sound to be output from a first virtual object during a play of a game by a user;
determine, using an artificial intelligence (AI) model, that the first sound is not preferred to be heard by the user;
provide an indication to a game engine that the first sound is not preferred to be heard from the user; and
modify, using the game engine, the first audio data with second audio data to be output as a second sound preferred to be heard by the user; and
a memory device coupled to the processor.

9. The server system of claim 8, wherein the processor is configured to:
determine whether a permission to modify the first audio data exists, wherein the first audio data is modified in response to determining that the permission exists.

10. The server system of claim 8, wherein the processor is configured to send the second audio data instead of the first audio data via a computer network to a client device for outputting the second sound.

11. The server system of claim 8, wherein the processor is configured to:
receive, using the AI model, game context data of the game, wherein the game context data identifies the first virtual object and a second virtual object, the first audio data of the first sound output from the first virtual object, and second audio data of a third sound output from the second virtual object;
receive, using the AI model, controller input data, wherein the controller input data identifies a first set of one or more buttons selected on one or more game controllers or one or more movements of a second set of one or more buttons selected on the one or more game controllers or a combination thereof;
receive, using the AI model, audio information generated from a voice of the user;
receive, using the AI model, textual data from one or more user accounts assigned to the user and an additional user;
receive, using the AI model, image data identifying a body expression from the user and an additional body expression from the additional user; and
receive, using the AI model, parameter setting data identifying one or more levels of one or more parameters of one or more sounds to be output by the first virtual object and the second virtual object.

12. The server system of claim 11, wherein the processor is configured to:
identify, from the game context data, the first virtual object and the second virtual object and the first audio data of the first sound output from the first virtual object and the second audio data of the third sound output from the second virtual object, wherein the first and second virtual objects and the first and second audio data are identified using the AI model;
identify, from the controller input data, the first set of one or more buttons selected on the one or more game controllers or the one or more movements of the second set of one or more buttons selected on the one or more game controllers or the combination thereof, wherein the first set of one or more buttons, the one or more movements, or the combination thereof are identified using the AI model;
identify, from the audio information, an emotion of the user towards the first sound and an additional emotion of the additional user towards the first sound or the third sound output from the second virtual object, wherein the emotion and the additional emotion are identified using the AI model;
identify, from the textual data, a liking of the user towards the first sound and an additional liking of the additional user towards the first sound or the third sound, wherein the liking and the additional liking are identified using the AI model;
identify, from the image data by the AI model, the body expression of the user towards the first sound and the additional body expression of the additional user towards the first sound or the third sound, wherein the body expression and the additional body expression are identified using the AI model; and
identify, from the parameter setting data, a level of a parameter of the first sound and an additional level of the parameter of the third sound, wherein the level and the additional level are identified using the AI model.

13. The server system of claim 12, wherein the processor is configured to:
classify, using the AI model, the first sound as scary or less scary and the third sound as scary or less scary;
classify, using the AI model, a first preference of the user towards the first sound based on the selection of the first set of one or more buttons or the one or more movements of the second set of one or more buttons selected on the one or more game controllers or the combination thereof, wherein the first preference of the user is classified to output a first classification signal;
classify, using the AI model, a second preference of the user towards the first sound based on the emotion of the user towards the first sound or the additional emotion of the additional user towards the first sound or the third sound output from the second virtual object, wherein the second preference of the user is classified to output a second classification signal;
classify, using the AI model, a third preference of the user towards the first sound based on the liking of the user towards the first sound or the additional liking of the additional user towards the first sound or the third sound, wherein the third preference of the user is classified to output a third classification signal;
classify, using the AI model, a fourth preference of the user towards the first sound based on the body expression of the user towards the first sound or the additional body expression of the additional user towards the first sound or the third sound, wherein the fourth preference of the user is classified to output a fourth classification signal; and
classify, using the AI model, a fifth preference of the user towards the first sound based on the level of the parameter of the first sound and the additional level of the parameter of the third sound, wherein the fifth preference of the user is classified to output a fifth classification signal.

14. The server system of claim 13, wherein the processor is configured to train the AI model based on the first classification signal, the second classification signal, the third classification signal, the fourth classification signal, and the fifth classification signal.

15. A non-transitory computer-readable medium that stores instructions for modifying a sound based on user preferences, the instructions when executed by a computer cause the computer to:
receive first audio data of a first sound to be output from a first virtual object during a play of a game by a user;
determine, using an artificial intelligence (AI) model, that the first sound is not preferred to be heard by the user;
provide an indication to a game engine that the first sound is not preferred to be heard from the user; and
modify, using the game engine, the first audio data with second audio data to be output as a second sound preferred to be heard by the user.

16. The non-transitory computer-readable medium of claim 15, wherein the instructions when executed cause the computer to:
determine whether a permission to modify the first audio data exists, wherein said modifying the first audio data occurs in response to determining that the permission exists.

17. The non-transitory computer-readable medium of claim 15, wherein the instructions when executed cause the computer to send the second audio data instead of the first audio data via a computer network to a client device for outputting the second sound.

18. The non-transitory computer-readable medium of claim 15, wherein the instructions when executed cause the computer to:
receive, using the AI model, game context data of the game, wherein the game context data identifies the first virtual object and a second virtual object, the first audio data of the first sound output from the first virtual object, and second audio data of a third sound output from the second virtual object;
receive, using the AI model, controller input data, wherein the controller input data identifies a first set of one or more buttons selected on one or more game controllers or one or more movements of a second set of one or more buttons selected on the one or more game controllers or a combination thereof;
receive, using the AI model, audio information generated from a voice of the user;
receive, using the AI model, textual data from one or more user accounts assigned to the user and an additional user;
receive, using the AI model, image data identifying a body expression from the user and an additional body expression from the additional user; and
receive, using the AI model, parameter setting data identifying one or more levels of one or more parameters of one or more sounds to be output by the first virtual object and the second virtual object.

19. The non-transitory computer-readable medium of claim 18, wherein the instructions when executed cause the computer to:
identify, from the game context data, the first virtual object and the second virtual object and the first audio data of the first sound output from the first virtual object and the second audio data of the third sound output from the second virtual object, wherein the first and second virtual objects and the first and second audio data are identified using the AI model;
identify, from the controller input data, the first set of one or more buttons selected on the one or more game controllers or the one or more movements of the second set of one or more buttons selected on the one or more game controllers or the combination thereof, wherein the first set of one or more buttons, the one or more movements, or the combination thereof are identified using the AI model;
identify, from the audio information, an emotion of the user towards the first sound and an additional emotion of the additional user towards the first sound or the third sound output from the second virtual object, wherein the emotion and the additional emotion are identified using the AI model;
identify, from the textual data, a liking of the user towards the first sound and an additional liking of the additional user towards the first sound or the third sound, wherein the liking and the additional liking are identified using the AI model;
identify, from the image data by the AI model, the body expression of the user towards the first sound and the additional body expression of the additional user towards the first sound or the third sound, wherein the body expression and the additional body expression are identified using the AI model; and
identify, from the parameter setting data, a level of a parameter of the first sound and an additional level of the parameter of the third sound, wherein the level and the additional level are identified using the AI model.

20. The non-transitory computer-readable medium of claim 19, wherein the instructions when executed cause the computer to:
classify, using the AI model, the first sound as scary or less scary and the third sound as scary or less scary;
classify, using the AI model, a first preference of the user towards the first sound based on the selection of the first set of one or more buttons or the one or more movements of the second set of one or more buttons selected on the one or more game controllers or the combination thereof, wherein the first preference of the user is classified to output a first classification signal;
classify, using the AI model, a second preference of the user towards the first sound based on the emotion of the user towards the first sound or the additional emotion of the additional user towards the first sound or the third sound output from the second virtual object, wherein the second preference of the user is classified to output a second classification signal;
classify, using the AI model, a third preference of the user towards the first sound based on the liking of the user towards the first sound or the additional liking of the additional user towards the first sound or the third sound, wherein the third preference of the user is classified to output a third classification signal;
classify, using the AI model, a fourth preference of the user towards the first sound based on the body expression of the user towards the first sound or the additional body expression of the additional user towards the first sound or the third sound, wherein the fourth preference of the user is classified to output a fourth classification signal; and
classify, using the AI model, a fifth preference of the user towards the first sound based on the level of the parameter of the first sound and the additional level of the parameter of the third sound, wherein the fifth preference of the user is classified to output a fifth classification signal; and
train the AI model based on the first classification signal, the second classification signal, the third classification signal, the fourth classification signal, and the fifth classification signal.
